(19) United States
(12) Patent Application Publication
(10) Pub. No.: US 2020/0042083 A1
(43) Pub. Date: Feb. 6, 2020

(54) XR DEVICE FOR PROVIDING AR MODE AND VR MODE AND METHOD OF CONTROLLING THE SAME

(71) Applicant: LG ELECTRONICS INC., Seoul (KR)

(72) Inventor: Dongog MIN, Seoul (KR)

(73) Assignee: LG ELECTRONICS INC., Seoul (KR)

(21) Appl. No.: 16/545,930

(22) Filed: Aug. 20, 2019

(30) Foreign Application Priority Data
Jul. 1, 2019 (KR) 10-2019-0078866

(51) Int. Cl. G06F 3/01; G09G 5/37

(52) U.S. Cl. CPC G06F 3/013; G09G 2354/00; G09G 5/37; G06F 3/017

(57) ABSTRACT

An extended reality (XR) device for providing augmented reality (AR) mode and virtual reality (VR) mode, and a method of controlling the same are disclosed. The XR device and the control method are applicable to all of the technical fields of 5^{th} generation (5G) communication, robots, self-driving, and artificial intelligence (AI).

Pursuant to 35 U.S.C. § 119(a), this application claims the benefit of earlier filing date and right of priority to Korean Patent Application No. 10-2019-0078866, filed on Jul. 1, 2019, the contents of which are hereby incorporated by reference herein in its entirety.

### BACKGROUND OF THE INVENTION

### Field of the Invention

The present disclosure relates to an extended reality (XR) device for providing augmented reality (AR) mode and virtual reality (VR) mode and a method of controlling the same. More particularly, the present disclosure is applicable to all of the technical fields of 5^{th} generation (5G) communication, robots, self-driving, and artificial intelligence (AI).

### Discussion of the Related Art

Virtual reality (VR) simulates objects or a background in the real world only in computer graphic (CG) images. Augmented reality (AR) is an overlay of virtual CG images on images of objects in the real world. Mixed reality (MR) is a CG technology of merging the real world with virtual objects. All of VR, AR and MR are collectively referred to shortly as extended reality (XR).

In the recent years, providing both AR mode and VR mode in a single device has been discussed.

However, because a virtual CG image is overlaid on an image of the real world in the AR mode (or AR device) as described above, the AR device takes much time in retrieving specific items on a user basis in addition to AR content provided by the AR device.

Moreover, an image of a real object is basically displayed in the AR mode. That is, when only a two-dimensional (2D) fixed user interface (UI) is provided in a domain using a multi-dimensional space such as a three-dimensional (3D) space, complexity increases and a user's fast recognition is not easy.

### SUMMARY OF THE INVENTION

Accordingly, the present disclosure is directed to an extended reality (XR) device for providing augmented reality (AR) mode and virtual reality (VR) mode and a method of controlling the same that substantially obviate one or more problems due to limitations and disadvantages of the related art.

An aspect of the present disclosure is to separately provide a domain customized for each user in a three-dimensional (3D) space of AR mode.

Another aspect of the present disclosure is to provide an XR service in which an AR-mode real object and a personalized object rendered by VR are provided together under a predetermined trigger condition.

Another aspect of the present disclosure is to provide an inventory system for providing a real object of AR mode and an object of VR mode in different modes.

Another aspect of the present disclosure is to reduce a sense of difference between AR mode and VR mode by reconstructing a personalized VR-mode background screen based on a real object captured in AR mode.

Another aspect of the present disclosure is to provide a service which enables fast switching from AR mode to VR mode or from the VR mode to the AR mode.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, A control method of an extended reality (XR) device for providing augmented reality (AR) mode and virtual reality (VR) mode includes executing the AR mode, displaying a screen of the AR mod, when a predetermined trigger condition is satisfied during execution of the AR mode, accessing a memory and extracting additional information related to the VR mode from the memory, and displaying, on the screen of the AR mode, a virtual object located at a specific position on a screen of the VR mode, based on the extracted additional information related to the VR mode.

For example, the screen of the AR mode may include an object captured by a camera of the XR device, and the screen of the VR mode may include at least one virtual object mapped to each position.

For example, at least one virtual object mapped to each position on the screen of the VR mode may be changed for each user recognized by the XR device.

The control method may further include tracking a user's gaze or a specific device by the XR device.

For example, the trigger condition may include recognition of the user's gaze or the specific device in a specific area of the screen of the AR mode for a predetermined time.

For example, the trigger condition may include at least one of a first condition that a specific physical key button of the XR device or a corresponding remote control is pushed, a second condition that a specific motion of the XR device or the corresponding remote control is sensed, or a third condition that a specific gesture is sensed by a camera of the XR device. When the trigger condition corresponds to the third condition, the control method may further include changing the virtual object located at the specific position on the screen of the VR mode, displayed on the screen of the AR mode according to a size or position of an area formed by the specific gesture. The display of, on the screen of the AR mode, a virtual object located at a specific position on a screen of the VR mode, based on the extracted additional information related to the VR mode may include displaying an indicator for guiding to at least one virtual object on the screen of the VR mode during execution of the AR mode.

For example, the indicator may include at least one of first graphic data indicating a type of the at least one virtual object on the screen of the VR mode, second graphic data indicating a position of the at least one virtual object on the screen of the VR mode, or third graphic data indicating the number of the at least one virtual object on the screen of the VR mode.

A program to execute the above-described control method may be stored in a computer-readable recording medium or provided to the XR device via a server.

According to another aspect, an XR device for providing a plurality of modes related to XR includes a memory, a controller configured to execute a first mode among the plurality of modes, and a display displaying a screen of the first mode.

Particularly, when a predetermined trigger condition is satisfied during execution of the first mode, the controller is configured to access the memory and extract additional information related to a second mode from the memory, and control the display to display, on the screen of the first mode, a virtual object located at a specific position on a screen of the second mode, based on the extracted additional information related to the second mode.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating an exemplary resource grid to which physical signals/channels are mapped in a 3^{rd} generation partnership project (3GPP) system;

FIG. 2 is a diagram illustrating an exemplary method of transmitting and receiving 3GPP signals;

FIG. 3 is a diagram illustrating an exemplary structure of a synchronization signal block (SSB);

FIG. 4 is a diagram illustrating an exemplary random access procedure;

FIG. 5 is a diagram illustrating exemplary uplink (UL) transmission based on a UL grant;

FIG. 6 is a conceptual diagram illustrating exemplary physical channel processing;

FIG. 7 is a block diagram illustrating an exemplary transmitter and receiver for hybrid beamforming;

FIG. 8A is a diagram illustrating an exemplary narrowband operation, and FIG. 8B is a diagram illustrating exemplary machine type communication (MTC) channel repetition with radio frequency (RF) retuning;

FIG. 9 is a block diagram illustrating an exemplary wireless communication system to which proposed methods according to the present disclosure are applicable;

FIG. 10 is a block diagram illustrating an artificial intelligence (AI) device 100 according to an embodiment of the present disclosure;

FIG. 11 is a block diagram illustrating an AI server 200 according to an embodiment of the present disclosure;

FIG. 12 is a diagram illustrating an AI system 1 according to an embodiment of the present disclosure;

FIG. 13 is a block diagram illustrating an extended reality (XR) device according to embodiments of the present disclosure;

FIG. 14 is a detailed block diagram illustrating a memory illustrated in FIG. 13;

FIG. 15 is a block diagram illustrating a point cloud data processing system;

FIG. 16 is a block diagram illustrating a device including a learning processor;

FIG. 17 is a flowchart illustrating a process of providing an XR service by an XR device 1600 of the present disclosure, illustrated in FIG. 16;

FIG. 18 is a diagram illustrating the outer appearances of an XR device and a robot;

FIG. 19 is a flowchart illustrating a process of controlling a robot by using an XR device;

FIG. 20 is a diagram illustrating a vehicle that provides a self-driving service;

FIG. 21 is a flowchart illustrating a process of providing an augmented reality/virtual reality (AR/VR) service during a self-driving service in progress;

FIG. 22 is a diagram referred to for describing a trigger condition for switching from AR mode to VR mode according to an embodiment of the present disclosure;

FIG. 23 is a diagram illustrating a personalized VR-mode screen provided by an XR device according to an embodiment of the present disclosure;

FIG. 24 is a diagram referred to for describing a process of displaying a virtual object, which is located at a specific position on a VR-mode screen, on an AR-mode screen during display of the AR-mode screen according to an embodiment of the present disclosure;

FIG. 25 is a diagram referred to for describing a process of moving an object on a VR-mode screen to an AR-mode screen according to an embodiment of the present disclosure;

FIG. 26 is a diagram referred to for describing a process of changing the size of a displayed virtual object on a displayed VR-mode screen during display of an AR-mode screen according to an embodiment of the present disclosure;

FIG. 27 is a diagram referred to for describing a feedback process, when a virtual object at a predetermined position on a VR-mode screen is recognized during display of an AR-mode screen according to an embodiment of the present disclosure;

FIG. 28 is a diagram illustrating a first sub-embodiment of a graphical user interface (GUI) for guiding to the position of a virtual object on a VR-mode screen during display of an AR-mode screen according to an embodiment of the present disclosure;

FIG. 29 is a diagram illustrating a second sub-embodiment of a GUI for guiding to the position of a virtual object on a VR-mode screen during display of an AR-mode screen according to an embodiment of the present disclosure;

FIG. 30 is a diagram illustrating a third sub-embodiment of a GUI for guiding to the position of a virtual object on a VR-mode screen during display of an AR-mode screen according to an embodiment of the present disclosure;

FIG. 31 is a diagram illustrating a fourth sub-embodiment of a GUI for guiding to the position of a virtual object on a VR-mode screen during display of an AR-mode screen according to an embodiment of the present disclosure;

FIG. 32 is a diagram illustrating a fifth sub-embodiment of a GUI for guiding to the position of a virtual object on a VR-mode screen during display of an AR-mode screen according to an embodiment of the present disclosure;

FIG. 33 is a diagram illustrating two-dimensional (2D) and three-dimensional (3D) representations of a GUI for guiding to the position of a virtual object on a VR-mode screen during display of an AR-mode screen according to an embodiment of the present disclosure;

FIG. 34 is a diagram illustrating a process of providing an AR/VR service in an artificial intelligence (AI) environment by an XR device according to an embodiment of the present disclosure;

FIG. 35 is a diagram illustrating a process of providing an AR/VR service in a self-driving environment by an XR device according to an embodiment of the present disclosure;

FIG. 36 is a diagram illustrating a first process of providing an AR/VR service in a robot environment by an XR device according to an embodiment of the present disclosure;

FIG. 37 is a diagram illustrating a second process of providing an AR/VR service in a robot environment by an XR device according to an embodiment of the present disclosure;

FIG. 38 is a diagram illustrating a process of providing an AR/VR service in a self-driving, AI, robot, and 5^{th} generation (5G) environment by an XR device according to an embodiment of the present disclosure;

FIG. 39 is a flowchart illustrating an operation of providing an AR/VR service by an XR device according to an embodiment of the present disclosure; and

FIG. 40 is a diagram illustrating a data structure in a memory which stores parameters required for an XR device to provide an AR/VR service according to an embodiment of the present disclosure.

### DETAILED DESCRIPTION OF THE INVENTION

Reference will now be made in detail to embodiments of the present disclosure, examples of which are illustrated in the accompanying drawings. Wherever possible, the same reference numbers will be used throughout the drawings to refer to the same or like parts, and a redundant description will be avoided. The terms “module” and “unit” are interchangeably used only for easiness of description and thus they should not be considered as having distinctive meanings or roles. Further, a detailed description of well-known technology will not be given in describing embodiments of the present disclosure lest it should obscure the subject matter of the embodiments. The attached drawings are provided to help the understanding of the embodiments of the present disclosure, not limiting the scope of the present disclosure. It is to be understood that the present disclosure covers various modifications, equivalents, and/or alternatives falling within the scope and spirit of the present disclosure.

The following embodiments of the present disclosure are intended to embody the present disclosure, not limiting the scope of the present disclosure. What could easily be derived from the detailed description of the present disclosure and the embodiments by a person skilled in the art is interpreted as falling within the scope of the present disclosure.

The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### Introduction

In the disclosure, downlink (DL) refers to communication from a base station (BS) to a user equipment (UE), and uplink (UL) refers to communication from the UE to the BS. On DL, a transmitter may be a part of the BS and a receiver may be a part of the UE, whereas on UL, a transmitter may be a part of the UE and a receiver may be a part of the BS. A UE may be referred to as a first communication device, and a BS may be referred to as a second communication device in the present disclosure. The term BS may be replaced with fixed station, Node B, evolved Node B (eNB), next generation Node B (gNB), base transceiver system (BTS), access point (AP), network or 5^{th} generation (5G) network node, artificial intelligence (AI) system, road side unit (RSU), robot, augmented reality/virtual reality (AR/VR) system, and so on. The term UE may be replaced with terminal, mobile station (MS), user terminal (UT), mobile subscriber station (MSS), subscriber station (SS), advanced mobile station (AMS), wireless terminal (WT), device-to-device (D2D) device, vehicle, robot, AI device (or module), AR/VR device (or module), and so on.

The following technology may be used in various wireless access systems including code division multiple access (CDMA), frequency division multiple access (FDMA), time division multiple access (TDMA), orthogonal frequency division multiple access (OFDMA), and single carrier FDMA (SC-FDMA).

For the convenience of description, the present disclosure is described in the context of a 3^{rd} generation partnership project (3GPP) communication system (e.g., long term evolution-advanced (LTE-A) and new radio or new radio access technology (NR)), which should not be construed as limiting the present disclosure. For reference, 3GPP LTE is part of evolved universal mobile telecommunications system (E-UMTS) using evolved UMTS terrestrial radio access (E-UTRA), and LTE-A/LTE-A pro is an evolution of 3GPP LTE. 3GPP NR is an evolution of 3GPP/LTE-A/LTE-A pro.

In the present disclosure, a node refers to a fixed point capable of transmitting/receiving wireless signals by communicating with a UE. Various types of BSs may be used as nodes irrespective of their names. For example, any of a BS, an NB, an eNB, a pico-cell eNB (PeNB), a home eNB (HeNB), a relay, and a repeater may be a node. At least one antenna is installed in one node. The antenna may refer to a physical antenna, an antenna port, a virtual antenna, or an antenna group. A node is also referred to as a point.

In the present disclosure, a cell may refer to a certain geographical area or radio resources, in which one or more nodes provide a communication service. A “cell” as a geographical area may be understood as coverage in which a service may be provided in a carrier, while a “cell” as radio resources is associated with the size of a frequency configured in the carrier, that is, a bandwidth (BW). Because a range in which a node may transmit a valid signal, that is, DL coverage and a range in which the node may receive a valid signal from a UE, that is, UL coverage depend on a carrier carrying the signals, and thus the coverage of the node is associated with the “cell” coverage of radio resources used by the node. Accordingly, the term “cell” may mean the service overage of a node, radio resources, or a range in which a signal reaches with a valid strength in the radio resources, under circumstances.

In the present disclosure, communication with a specific cell may amount to communication with a BS or node that provides a communication service to the specific cell. Further, a DL/UL signal of a specific cell means a DL/UL signal from/to a BS or node that provides a communication service to the specific cell. Particularly, a cell that provides a UL/DL communication service to a UE is called a serving cell for the UE. Further, the channel state/quality of a specific cell refers to the channel state/quality of a channel or a communication link established between a UE and a BS or node that provides a communication service to the specific cell.

A “cell” associated with radio resources may be defined as a combination of DL resources and UL resources, that is, a combination of a DL component carrier (CC) and a UL CC. A cell may be configured with DL resources alone or both DL resources and UL resources in combination. When carrier aggregation (CA) is supported, linkage between the carrier frequency of DL resources (or a DL CC) and the carrier frequency of UL resources (or a UL CC) may be indicated by system information transmitted in a corresponding cell. A carrier frequency may be identical to or different from the center frequency of each cell or CC. Hereinbelow, a cell operating in a primary frequency is referred to as a primary cell (Pcell) or PCC, and a cell operating in a secondary frequency is referred to as a secondary cell (Scell) or SCC. The Scell may be configured after a UE and a BS perform a radio resource control (RRC) connection establishment procedure and thus an RRC connection is established between the UE and the BS, that is, the UE is RRC CONNECTED. The RRC connection may mean a path in which the RRC of the UE may exchange RRC messages with the RRC of the BS. The Scell may be configured to provide additional radio resources to the UE. The Scell and the Pcell may form a set of serving cells for the UE according to the capabilities of the UE. Only one serving cell configured with a Pcell exists for an RRC CONNECTED UE which is not configured with CA or does not support CA.

A cell supports a unique radio access technology (RAT). For example, LTE RAT-based transmission/reception is performed in an LTE cell, and 5G RAT-based transmission/reception is performed in a 5G cell.

CA aggregates a plurality of carriers each having a smaller system BW than a target BW to support broadband. CA differs from OFDMA in that DL or UL communication is conducted in a plurality of carrier frequencies each forming a system BW (or channel BW) in the former, and DL or UL communication is conducted by loading a basic frequency band divided into a plurality of orthogonal subcarriers in one carrier frequency in the latter. In OFDMA or orthogonal frequency division multiplexing (OFDM), for example, one frequency band having a certain system BW is divided into a plurality of subcarriers with a predetermined subcarrier spacing, information/data is mapped to the plurality of subcarriers, and the frequency band in which the information/data has been mapped is transmitted in a carrier frequency of the frequency band through frequency upconversion. In wireless CA, frequency bands each having a system BW and a carrier frequency may be used simultaneously for communication, and each frequency band used in CA may be divided into a plurality of subcarriers with a predetermined subcarrier spacing.

The 3GPP communication standards define DL physical channels corresponding to resource elements (REs) conveying information originated from upper layers of the physical layer (e.g., the medium access control (MAC) layer, the radio link control (RLC) layer, the packet data convergence protocol (PDCP) layer, the radio resource control (RRC) layer, the service data adaptation protocol (SDAP) layer, and the non-access stratum (NAS) layer), and DL physical signals corresponding to REs which are used in the physical layer but do not deliver information originated from the upper layers. For example, physical downlink shared channel (PDSCH), physical broadcast channel (PBCH), physical multicast channel (PMCH), physical control format indicator channel (PCFICH), and physical downlink control channel (PDCCH) are defined as DL physical channels, and a reference signal (RS) and a synchronization signal are defined as DL physical signals. An RS, also called a pilot is a signal in a predefined special waveform known to both a BS and a UE. For example, cell specific RS (CRS), UE-specific RS (UE-RS), positioning RS (PRS), channel state information RS (CSI-RS), and demodulation RS (DMRS) are defined as DL RSs. The 3GPP communication standards also define UL physical channels corresponding to REs conveying information originated from upper layers, and UL physical signals corresponding to REs which are used in the physical layer but do not carry information originated from the upper layers. For example, physical uplink shared channel (PUSCH), physical uplink control channel (PUCCH), and physical random access channel (PRACH) are defined as UL physical channels, and DMRS for a UL control/data signal and sounding reference signal (SRS) used for UL channel measurement are defined.

In the present disclosure, physical shared channels (e.g., PUSCH and PDSCH) are used to deliver information originated from the upper layers of the physical layer (e.g., the MAC layer, the RLC layer, the PDCP layer, the RRC layer, the SDAP layer, and the NAS layer).

In the present disclosure, an RS is a signal in a predefined special waveform known to both a BS and a UE. In a 3GPP communication system, for example, the CRS being a cell common RS, the UE-RS for demodulation of a physical channel of a specific UE, the CSI-RS used to measure/estimate a DL channel state, and the DMRS used to demodulate a physical channel are defined as DL RSs, and the DMRS used for demodulation of a UL control/data signal and the SRS used for UL channel state measurement/estimation are defined as UL RSs.

In the present disclosure, a transport block (TB) is payload for the physical layer. For example, data provided to the physical layer by an upper layer or the MAC layer is basically referred to as a TB. A UE which is a device including an AR/VR module (i.e., an AR/VR device) may transmit a TB including AR/VR data to a wireless communication network (e.g., a 5G network) on a PUSCH. Further, the UE may receive a TB including AR/VR data of the 5G network or a TB including a response to AR/VR data transmitted by the UE from the wireless communication network.

In the present disclosure, hybrid automatic repeat and request (HARQ) is a kind of error control technique. An HARQ acknowledgement (HARQ-ACK) transmitted on DL is used for error control of UL data, and a HARQ-ACK transmitted on UL is used for error control of DL data. A transmitter performing an HARQ operation awaits reception of an ACK after transmitting data (e.g., a TB or a codeword). A receiver performing an HARQ operation transmits an ACK only when data has been successfully received, and a negative ACK (NACK) when the received data has an error. Upon receipt of the ACK, the transmitter may transmit (new) data, and upon receipt of the NACK, the transmitter may retransmit the data.

In the present disclosure, CSI generically refers to information representing the quality of a radio channel (or link) established between a UE and an antenna port. The CSI may include at least one of a channel quality indicator (CQI), a precoding matrix indicator (PMI), a CSI-RS resource indicator (CRI), a synchronization signal block resource indicator (SSBRI), a layer indicator (LI), a rank indicator (RI), or a reference signal received power (RSRP).

In the present disclosure, frequency division multiplexing (FDM) is transmission/reception of signals/channels/users in different frequency resources, and time division multiplexing (TDM) is transmission/reception of signals/channels/users in different time resources.

In the present disclosure, frequency division duplex (FDD) is a communication scheme in which UL communication is performed in a UL carrier, and DL communication is performed in a DL carrier linked to the UL carrier, whereas time division duplex (TDD) is a communication scheme in which UL communication and DL communication are performed in time division in the same carrier. In the present disclosure, half-duplex is a scheme in which a communication device operates on UL or UL only in one frequency at one time point, and on DL or UL in another frequency at another time point. For example, when the communication device operates in half-duplex, the communication device communicates in UL and DL frequencies, wherein the communication device performs a UL transmission in the UL frequency for a predetermined time, and retunes to the DL frequency and performs a DL reception in the DL frequency for another predetermined time, in time division, without simultaneously using the UL and DL frequencies.

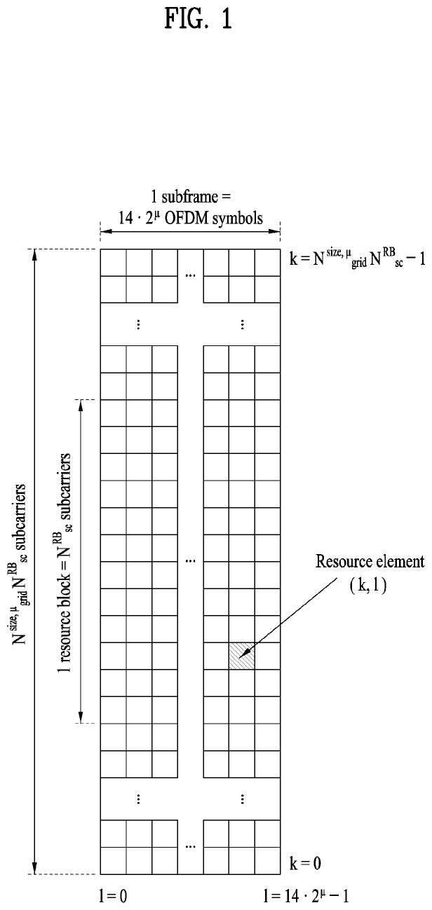

FIG. 1 is a diagram illustrating an exemplary resource grid to which physical signals/channels are mapped in a 3GPP system.

Referring to FIG. 1, for each subcarrier spacing configuration and carrier, a resource grid of N^{size,μ}grid*N^{RB}sc subcarriers by 14·2^{μ} OFDM symbols is defined. Herein, N^{size,μ}grid is indicated by RRC signaling from a BS, and μ represents a subcarrier spacing Δf given by Δf=2 μ*15 [kHz] where μϵ{0, 1, 2, 3, 4} in a 5G system.

N^{size,μ}grid may be different between UL and DL as well as a subcarrier spacing configuration μFor the subcarrier spacing configuration μ, an antenna port p, and a transmission direction (UL or DL), there is one resource grid. Each element of a resource grid for the subcarrier spacing configuration μ and the antenna port p is referred to as an RE, uniquely identified by an index pair (k,l) where k is a frequency-domain index and 1 is the position of a symbol in a relative time domain with respect to a reference point. A frequency unit used for mapping physical channels to REs, resource block (RB) is defined by 12 consecutive subcarriers (N^{RB}sc=12) in the frequency domain. Considering that a UE may not support a wide BW supported by the 5G system at one time, the UE may be configured to operate in a part (referred to as a bandwidth part (BWP)) of the frequency BW of a cell.

For the background technology, terminology, and abbreviations used in the present disclosure, standard specifications published before the present disclosure may be referred to. For example, the following documents may be referred to.

3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2-Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol
3GPP TS 23.303: Proximity-based services (Prose); Stage 2
3GPP TS 23.285: Architecture enhancements for V2X services
3GPP TS 23.401: General Packet Radio Service (GPRS) enhancements for Evolved Universal Terrestrial Radio Access Network (E-UTRAN) access
3GPP TS 23.402: Architecture enhancements for non-3GPP accesses
3GPP TS 23.286: Application layer support for V2X services; Functional architecture and information flows
3GPP TS 24.301: Non-Access-Stratum (NAS) protocol for Evolved Packet System (EPS); Stage 3
3GPP TS 24.302: Access to the 3GPP Evolved Packet Core (EPC) via non-3GPP access networks; Stage 3
3GPP TS 24.334: Proximity-services (ProSe) User Equipment (UE) to ProSe function protocol aspects; Stage 3
3GPP TS 24.386: User Equipment (UE) to V2X control function; protocol aspects; Stage 3
3GPP NR (e.g. 5G)
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (SGCN) via non-3GPP access networks
3GPP TS 24.526: User Equipment (UE) policies for 5G System (5GS); Stage 3

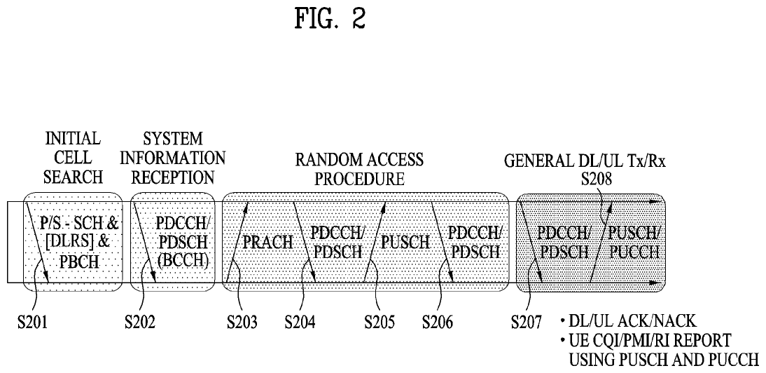

FIG. 2 is a diagram illustrating an exemplary method of transmitting/receiving 3GPP signals.

Referring to FIG. 2, when a UE is powered on or enters a new cell, the UE performs an initial cell search involving acquisition of synchronization with a BS (S201). For the initial cell search, the UE receives a primary synchronization channel (P-SCH) and a secondary synchronization channel (S-SCH), acquires synchronization with the BS, and obtains information such as a cell identifier (ID) from the P-SCH and the S-SCH. In the LTE system and the NR system, the P-SCH and the S-SCH are referred to as a primary synchronization signal (PSS) and a secondary synchronization signal (SSS), respectively. The initial cell search procedure will be described below in greater detail.

After the initial cell search, the UE may receive a PBCH from the BS and acquire broadcast information within a cell from the PBCH. During the initial cell search, the UE may check a DL channel state by receiving a DL RS.

Upon completion of the initial cell search, the UE may acquire more specific system information by receiving a PDCCH and receiving a PDSCH according to information carried on the PDCCH (S202).

When the UE initially accesses the BS or has no radio resources for signal transmission, the UE may perform a random access procedure with the BS (S203 to S206). For this purpose, the UE may transmit a predetermined sequence as a preamble on a PRACH (S203 and S205) and receive a PDCCH, and a random access response (RAR) message in response to the preamble on a PDSCH corresponding to the PDCCH (S204 and S206). If the random access procedure is contention-based, the UE may additionally perform a contention resolution procedure. The random access procedure will be described below in greater detail.

After the above procedure, the UE may then perform PDCCH/PDSCH reception (S207) and PUSCH/PUCCH transmission (S208) in a general UL/DL signal transmission procedure. Particularly, the UE receives DCI on a PDCCH.

The UE monitors a set of PDCCH candidates in monitoring occasions configured for one or more control element sets (CORESETs) in a serving cell according to a corresponding search space configuration. The set of PDCCH candidates to be monitored by the UE is defined from the perspective of search space sets. A search space set may be a common search space set or a UE-specific search space set. A CORESET includes a set of (physical) RBs that last for a time duration of one to three OFDM symbols. The network may configure a plurality of CORESETs for the UE. The UE monitors PDCCH candidates in one or more search space sets. Herein, monitoring is attempting to decode PDCCH candidate(s) in a search space. When the UE succeeds in decoding one of the PDCCH candidates in the search space, the UE determines that a PDCCH has been detected from among the PDCCH candidates and performs PDSCH reception or PUSCH transmission based on DCI included in the detected PDCCH.

The PDCCH may be used to schedule DL transmissions on a PDSCH and UL transmissions on a PUSCH. DCI in the PDCCH includes a DL assignment (i.e., a DL grant) including at least a modulation and coding format and resource allocation information for a DL shared channel, and a UL grant including a modulation and coding format and resource allocation information for a UL shared channel.

### Initial Access (IA) Procedure

### Synchronization Signal Block (SSB) Transmission and Related Operation

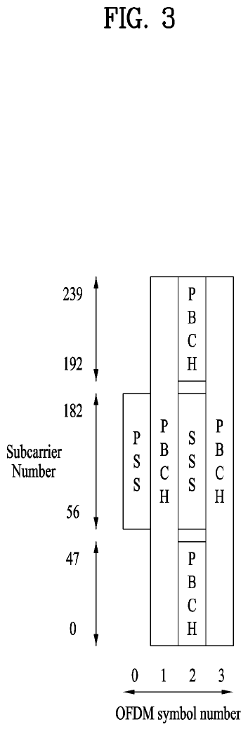

FIG. 3 is a diagram illustrating an exemplary SSB structure. The UE may perform cell search, system information acquisition, beam alignment for initial access, DL measurement, and so on, based on an SSB. The term SSB is interchangeably used with synchronization signal/physical broadcast channel (SS/PBCH).

Referring to FIG. 3, an SSB includes a PSS, an SSS, and a PBCH. The SSB includes four consecutive OFDM symbols, and the PSS, the PBCH, the SSS/PBCH, or the PBCH is transmitted in each of the OFDM symbols. The PBCH is encoded/decoded based on a polar code and modulated/demodulated in quadrature phase shift keying (QPSK). The PBCH in an OFDM symbol includes data REs to which a complex modulated value of the PBCH is mapped and DMRS REs to which a DMRS for the PBCH is mapped. There are three DMRS REs per RB in an OFDM symbol and three data REs between every two of the DMRS REs.

### Cell Search

Cell search is a process of acquiring the time/frequency synchronization of a cell and detecting the cell ID (e.g., physical cell ID (PCI)) of the cell by a UE. The PSS is used to detect a cell ID in a cell ID group, and the SSS is used to detect the cell ID group. The PBCH is used for SSB (time) index detection and half-frame detection.

In the 5G system, there are 336 cell ID groups each including 3 cell IDs. Therefore, a total of 1008 cell IDs are available. Information about a cell ID group to which the cell ID of a cell belongs is provided/acquired by/from the SSS of the cell, and information about the cell ID among 336 cells within the cell ID is provided/acquired by/from the PSS.

The SSB is periodically transmitted with an SSB periodicity. The UE assumes a default SSB periodicity of 20 ms during initial cell search. After cell access, the SSB periodicity may be set to one of {5 ms, 10 ms, 20 ms, 40 ms, 80 ms, 160 ms} by the network (e.g., a BS). An SSB burst set is configured at the start of an SSB period. The SSB burst set is composed of a 5-ms time window (i.e., half-frame), and the SSB may be transmitted up to L times within the SSB burst set. The maximum number L of SSB transmissions may be given as follows according to the frequency band of a carrier.
For frequency range up to 3 GHz, L=4
For frequency range from 3GHz to 6 GHz, L=8
For frequency range from 6 GHz to 52.6 GHz, L=64

The possible time positions of SSBs in a half-frame are determined by a subcarrier spacing, and the periodicity of half-frames carrying SSBs is configured by the network. The time positions of SSB candidates are indexed as 0 to L-1 (SSB indexes) in a time order in an SSB burst set (i.e., half-frame). Other SSBs may be transmitted in different spatial directions (by different beams spanning the coverage area of the cell) during the duration of a half-frame. Accordingly, an SSB index (SSBI) may be associated with a BS transmission (Tx) beam in the 5G system.

The UE may acquire DL synchronization by detecting an SSB. The UE may identify the structure of an SSB burst set based on a detected (time) SSBI and hence a symbol/slot/half-frame boundary. The number of a frame/half-frame to which the detected SSB belongs may be identified by using system frame number (SFN) information and half-frame indication information.

Specifically, the UE may acquire the 10-bit SFN of a frame carrying the PBCH from the PBCH. Subsequently, the UE may acquire 1-bit half-frame indication information. For example, when the UE detects a PBCH with a half-frame indication bit set to 0, the UE may determine that an SSB to which the PBCH belongs is in the first half-frame of the frame. When the UE detects a PBCH with a half-frame indication bit set to 1, the UE may determine that an SSB to which the PBCH belongs is in the second half-frame of the frame. Finally, the UE may acquire the SSBI of the SSB to which the PBCH belongs based on a DMRS sequence and PBCH payload delivered on the PBCH.

### System Information (SI) Acquisition

SI is divided into a master information block (MIB) and a plurality of system information blocks (SIBs). The SI except for the MIB may be referred to as remaining minimum system information (RMSI). For details, the following may be referred to.
The MIB includes information/parameters for monitoring a PDCCH that schedules a PDSCH carrying systemInformationBlock1 (SIB1), and transmitted on a PBCH of an SSB by a BS. For example, a UE may determine from the MIB whether there is any CORESET for a TypeO-PDCCH common search space. The TypeO-PDCCH common search space is a kind of PDCCH search space and used to transmit a PDCCH that schedules an SI message. In the presence of a TypeO-PDCCH common search space, the UE may determine (1) a plurality of contiguous RBs and one or more consecutive symbols included in a CORESET, and (ii) a PDCCH occasion (e.g., a time-domain position at which a PDCCH is to be received), based on information (e.g., pdcch-ConfigSIB1) included in the MIB.
SIB1 includes information related to availability and scheduling (e.g., a transmission period and an SI-window size) of the remaining SIBs (hereinafter, referred to SIBx where x is an integer equal to or larger than 2). For example, SIB1 may indicate whether SIBx is broadcast periodically or in an on-demand manner upon user request. If SIBx is provided in the on-demand manner, SIB1 may include information required for the UE to transmit an SI request. A PDCCH that schedules SIB1 is transmitted in the Type0-PDCCH common search space, and SIB1 is transmitted on a PDSCH indicated by the PDCCH.
SIBx is included in an SI message and transmitted on a PDSCH. Each SI message is transmitted within a periodic time window (i.e., SI-window).

### Random Access Procedure

The random access procedure serves various purposes. For example, the random access procedure may be used for network initial access, handover, and UE-triggered UL data transmission. The UE may acquire UL synchronization and UL transmission resources in the random access procedure. The random access procedure may be contention-based or contention-free.

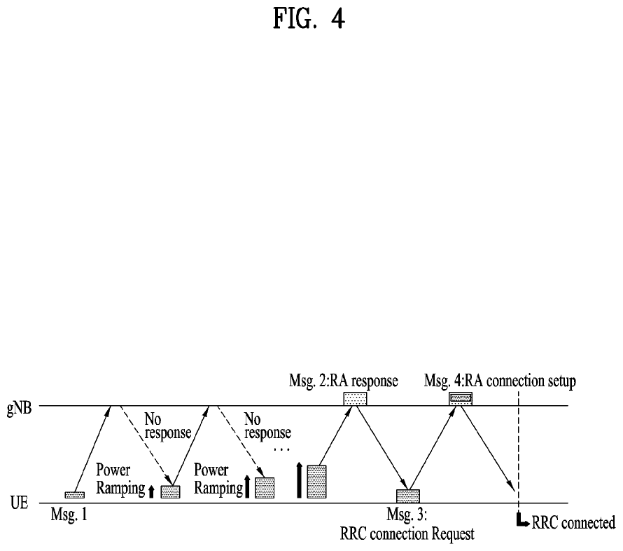

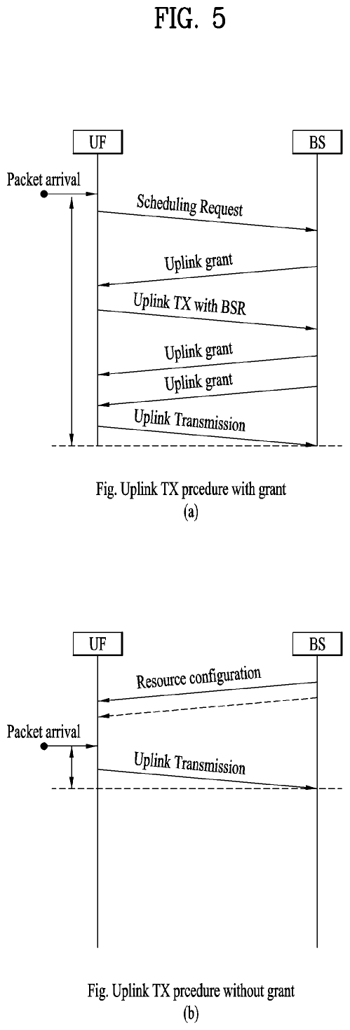

FIG. 4 is a diagram illustrating an exemplary random access procedure. Particularly, FIG. 4 illustrates a contention-based random access procedure.

First, a UE may transmit a random access preamble as a first message (Msg1) of the random access procedure on a PRACH. In the present disclosure, a random access procedure and a random access preamble are also referred to as a RACH procedure and a RACH preamble, respectively.

A plurality of preamble formats are defined by one or more RACH OFDM symbols and different cyclic prefixes (CPs) (and/or guard times). A RACH configuration for a cell is included in system information of the cell and provided to the UE. The RACH configuration includes information about a subcarrier spacing, available preambles, a preamble format, and so on for a PRACH. The RACH configuration includes association information between SSBs and RACH (time-frequency) resources, that is, association information between SSBIs and RACH (time-frequency) resources. The SSBIs are associated with Tx beams of a BS, respectively. The UE transmits a RACH preamble in RACH time-frequency resources associated with a detected or selected SSB. The BS may identify a preferred BS Tx beam of the UE based on time-frequency resources in which the RACH preamble has been detected.

An SSB threshold for RACH resource association may be configured by the network, and a RACH preamble transmission (i.e., PRACH transmission) or retransmission is performed based on an SSB in which an RSRP satisfying the threshold has been measured. For example, the UE may select one of SSB(s) satisfying the threshold and transmit or retransmit the RACH preamble in RACH resources associated with the selected SSB.

Upon receipt of the RACH preamble from the UE, the BS transmits an RAR message (a second message (Msg2)) to the UE. A PDCCH that schedules a PDSCH carrying the RAR message is cyclic redundancy check (CRC)-masked by an RA radio network temporary identifier (RNTI) (RA-RNTI) and transmitted. When the UE detects the PDCCH masked by the RA-RNTI, the UE may receive the RAR message on the PDSCH scheduled by DCI delivered on the PDCCH. The UE determines whether RAR information for the transmitted preamble, that is, Msg1 is included in the RAR message. The UE may determine whether random access information for the transmitted Msg1 is included by checking the presence or absence of the RACH preamble ID of the transmitted preamble. If the UE fails to receive a response to Msg1, the UE may transmit the RACH preamble a predetermined number of or fewer times, while performing power ramping. The UE calculates the PRACH transmission power of a preamble retransmission based on the latest pathloss and a power ramping counter.

Upon receipt of the RAR information for the UE on the PDSCH, the UE may acquire timing advance information for UL synchronization, an initial UL grant, and a UE temporary cell RNTI (C-RNTI). The timing advance information is used to control a UL signal transmission timing. To enable better alignment between PUSCH/PUCCH transmission of the UE and a subframe timing at a network end, the network (e.g., BS) may measure the time difference between PUSCH/PUCCH/SRS reception and a subframe and transmit the timing advance information based on the measured time difference. The UE may perform a UL transmission as a third message (Msg3) of the RACH procedure on a PUSCH. Msg3 may include an RRC connection request and a UE ID. The network may transmit a fourth message (Msg4) in response to Msg3, and Msg4 may be treated as a contention solution message on DL. As the UE receives Msg4, the UE may enter an RRC CONNECTED state.

The contention-free RACH procedure may be used for handover of the UE to another cell or BS or performed when requested by a BS command. The contention-free RACH procedure is basically similar to the contention-based RACH procedure. However, compared to the contention-based RACH procedure in which a preamble to be used is randomly selected among a plurality of RACH preambles, a preamble to be used by the UE (referred to as a dedicated RACH preamble) is allocated to the UE by the BS in the contention-free RACH procedure. Information about the dedicated RACH preamble may be included in an RRC message (e.g., a handover command) or provided to the UE by a PDCCH order. When the RACH procedure starts, the UE transmits the dedicated RACH preamble to the BS. When the UE receives the RACH procedure from the BS, the RACH procedure is completed.

### DL and UL Transmission/Reception Operations

### DL Transmission/Reception Operation

DL grants (also called DL assignments) may be classified into (1) dynamic grant and (2) configured grant. A dynamic grant is a data transmission/reception method based on dynamic scheduling of a BS, aiming to maximize resource utilization.

The BS schedules a DL transmission by DCI. The UE receives the DCI for DL scheduling (i.e., including scheduling information for a PDSCH) (referred to as DL grant DCI) from the BS. The DCI for DL scheduling may include, for example, the following information: a BWP indicator, a frequency-domain resource assignment, a time-domain resource assignment, and a modulation and coding scheme (MCS).

The UE may determine a modulation order, a target code rate, and a TB size (TBS) for the PDSCH based on an MCS field in the DCI. The UE may receive the PDSCH in time-frequency resources according to the frequency-domain resource assignment and the time-domain domain resource assignment.

The DL configured grant is also called semi-persistent scheduling (SPS). The UE may receive an RRC message including a resource configuration for DL data transmission from the BS. In the case of DL SPS, an actual DL configured grant is provided by a PDCCH, and the DL SPS is activated or deactivated by the PDCCH. When DL SPS is configured, the BS provides the UE with at least the following parameters by RRC signaling: a configured scheduling RNTI (CS-RNTI) for activation, deactivation, and retransmission; and a periodicity. An actual DL grant (e.g., a frequency resource assignment) for DL SPS is provided to the UE by DCI in a PDCCH addressed to the CS-RNTI. If a specific field in the DCI of the PDCCH addressed to the CS-RNTI is set to a specific value for scheduling activation, SPS associated with the CS-RNTI is activated. The DCI of the PDCCH addressed to the CS-RNTI includes actual frequency resource allocation information, an MCS index, and so on. The UE may receive DL data on a PDSCH based on the SPS.

### UL Transmission/Reception Operation

UL grants may be classified into (1) dynamic grant that schedules a PUSCH dynamically by UL grant DCI and (2) configured grant that schedules a PUSCH semi-statically by RRC signaling.

FIG. 5 is a diagram illustrating exemplary UL transmissions according to UL grants. Particularly, FIG. 5(a) illustrates a UL transmission procedure based on a dynamic grant, and FIG. 5(b) illustrates a UL transmission procedure based on a configured grant.

In the case of a UL dynamic grant, the BS transmits DCI including UL scheduling information to the UE. The UE receives DCI for UL scheduling (i.e., including scheduling information for a PUSCH) (referred to as UL grant DCI) on a PDCCH. The DCI for UL scheduling may include, for example, the following information: a BWP indicator, a frequency-domain resource assignment, a time-domain resource assignment, and an MCS. For efficient allocation of UL radio resources by the BS, the UE may transmit information about UL data to be transmitted to the BS, and the BS may allocate UL resources to the UE based on the information. The information about the UL data to be transmitted is referred to as a buffer status report (BSR), and the BSR is related to the amount of UL data stored in a buffer of the UE.

Referring to FIG. 5(a), the illustrated UL transmission procedure is for a UE which does not have UL radio resources available for BSR transmission. In the absence of a UL grant available for UL data transmission, the UE is not capable of transmitting a BSR on a PUSCH. Therefore, the UE should request resources for UL data, starting with transmission of an SR on a PUCCH. In this case, a 5-step UL resource allocation procedure is used.

Referring to FIG. 5(a), in the absence of PUSCH resources for BSR transmission, the UE first transmits an SR to the BS, for PUSCH resource allocation. The SR is used for the UE to request PUSCH resources for UL transmission to the BS, when no PUSCH resources are available to the UE in spite of occurrence of a buffer status reporting event. In the presence of valid PUCCH resources for the SR, the UE transmits the SR on a PUCCH, whereas in the absence of valid PUCCH resources for the SR, the UE starts the afore-described (contention-based) RACH procedure. Upon receipt of a UL grant in UL grant DCI from the BS, the UE transmits a BSR to the BS in PUSCH resources allocated by the UL grant. The BS checks the amount of UL data to be transmitted by the UE based on the BSR and transmits a UL grant in UL grant DCI to the UE. Upon detection of a PDCCH including the UL grant DCI, the UE transmits actual UL data to the BS on a PUSCH based on the UL grant included in the UL grant DCI.

Referring to FIG. 5(b), in the case of a configured grant, the UE receives an RRC message including a resource configuration for UL data transmission from the BS. In the NR system, two types of UL configured grants are defined: type 1 and type 2. In the case of UL configured grant type 1, an actual UL grant (e.g., time resources and frequency resources) is provided by RRC signaling, whereas in the case of UL configured grant type 2, an actual UL grant is provided by a PDCCH, and activated or deactivated by the PDCCH. If configured grant type 1 is configured, the BS provides the UE with at least the following parameters by RRC signaling: a CS-RNTI for retransmission; a periodicity of configured grant type 1; information about a starting symbol index S and the number L of symbols for a PUSCH in a slot; a time-domain offset representing a resource offset with respect to SFN=0 in the time domain; and an MCS index representing a modulation order, a target code rate, and a TB size. If configured grant type 2 is configured, the BS provides the UE with at least the following parameters by RRC signaling: a CS-RNTI for activation, deactivation, and retransmission; and a periodicity of configured grant type 2. An actual UL grant of configured grant type 2 is provided to the UE by DCI of a PDCCH addressed to a CS-RNTI. If a specific field in the DCI of the PDCCH addressed to the CS-RNTI is set to a specific value for scheduling activation, configured grant type 2 associated with the CS-RNTI is activated. The DCI set to a specific value for scheduling activation in the PDCCH includes actual frequency resource allocation information, an MCS index, and so on. The UE may perform a UL transmission on a PUSCH based on a configured grant of type 1 or type 2.

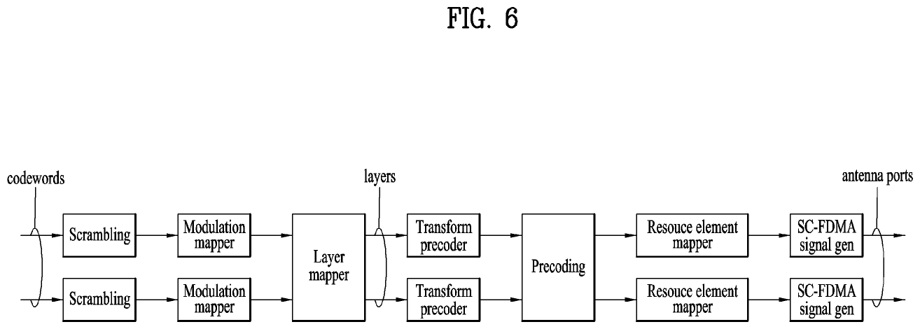

FIG. 6 is a conceptual diagram illustrating exemplary physical channel processing.

Each of the blocks illustrated in FIG. 6 may be performed in a corresponding module of a physical layer block in a transmission device. More specifically, the signal processing depicted in FIG. 6 may be performed for UL transmission by a processor of a UE described in the present disclosure. Signal processing of FIG. 6 except for transform precoding, with CP-OFDM signal generation instead of SC-FDMA signal generation may be performed for DL transmission in a processor of a BS described in the present disclosure. Referring to FIG. 6, UL physical channel processing may include scrambling, modulation mapping, layer mapping, transform precoding, precoding, RE mapping, and SC-FDMA signal generation. The above processes may be performed separately or together in the modules of the transmission device. The transform precoding, a kind of discrete Fourier transform (DFT), is to spread UL data in a special manner that reduces the peak-to-average power ratio (PAPR) of a waveform. OFDM which uses a CP together with transform precoding for DFT spreading is referred to as DFT-s-OFDM, and OFDM using a CP without DFT spreading is referred to as CP-OFDM. An SC-FDMA signal is generated by DFT-s-OFDM. In the NR system, if transform precoding is enabled for UL, transform precoding may be applied optionally. That is, the NR system supports two options for a UL waveform: one is CP-OFDM and the other is DFT-s-OFDM. The BS provides RRC parameters to the UE such that the UE determines whether to use CP-OFDM or DFT-s-OFDM for a UL transmission waveform. FIG. 6 is a conceptual view illustrating UL physical channel processing for DFT-s-OFDM. For CP-OFDM, transform precoding is omitted from the processes of FIG. 6. For DL transmission, CP-OFDM is used for DL waveform transmission.

Each of the above processes will be described in greater detail. For one codeword, the transmission device may scramble coded bits of the codeword by a scrambler and then transmit the scrambled bits on a physical channel. The codeword is obtained by encoding a TB. The scrambled bits are modulated to complex-valued modulation symbols by a modulation mapper. The modulation mapper may modulate the scrambled bits in a predetermined modulation scheme and arrange the modulated bits as complex-valued modulation symbols representing positions on a signal constellation. Pi/2-binay phase shift keying (pi/2-BPSK), m-phase shift keying (m-PSK), m-quadrature amplitude modulation (m-QAM), or the like is available for modulation of the coded data. The complex-valued modulation symbols may be mapped to one or more transmission layers by a layer mapper. A complexed-value modulation symbol on each layer may be precoded by a precoder, for transmission through an antenna port. If transform precoding is possible for UL transmission, the precoder may perform precoding after the complex-valued modulation symbols are subjected to transform precoding, as illustrated in FIG. 6. The precoder may output antenna-specific symbols by processing the complex-valued modulation symbols in a multiple input multiple output (MIMO) scheme according to multiple Tx antennas, and distribute the antenna-specific symbols to corresponding RE mappers. An output z of the precoder may be obtained by multiplying an output y of the layer mapper by an N×M precoding matrix, W where N is the number of antenna ports and M is the number of layers. The RE mappers map the complex-valued modulation symbols for the respective antenna ports to appropriate REs in an RB allocated for transmission. The RE mappers may map the complex-valued modulation symbols to appropriate subcarriers, and multiplex the mapped symbols according to users. SC-FDMA signal generators (CP-OFDM signal generators, when transform precoding is disabled in DL transmission or UL transmission) may generate complex-valued time domain OFDM symbol signals by modulating the complex-valued modulation symbols in a specific modulations scheme, for example, in OFDM. The SC-FDMA signal generators may perform inverse fast Fourier transform (IFFT) on the antenna-specific symbols and insert CPs into the time-domain IFFT-processed symbols. The OFDM symbols are subjected to digital-to-analog conversion, frequency upconversion, and so on, and then transmitted to a reception device through the respective Tx antennas. Each of the SC-FDMA signal generators may include an IFFT module, a CP inserter, a digital-to-analog converter (DAC), a frequency upconverter, and so on.

A signal processing procedure of the reception device is performed in a reverse order of the signal processing procedure of the transmission device. For details, refer to the above description and FIG. 6.

Now, a description will be given of the PUCCH.

The PUCCH is used for UCI transmission. UCI includes an SR requesting UL transmission resources, CSI representing a UE-measured DL channel state based on a DL RS, and/or an HARQ-ACK indicating whether a UE has successfully received DL data.

The PUCCH supports multiple formats, and the PUCCH formats are classified according to symbol durations, payload sizes, and multiplexing or non-multiplexing. [Table 1] below lists exemplary PUCCH formats.

TABLE 1

| | PUCCH | | | |
|---|---|---|---|---|
| | length | | | |
| | in OFDM | Number of | | |
| Format [symbol] | symbols [symbol] | bits [symbol] | Etc. [symbol] | [symbol] |
| 0 [symbol] | 1-2 [symbol] | ≤2 [symbol] | Sequence selection [symbol] | [symbol] |
| 1 [symbol] | 4-14 [symbol] | ≤2 [symbol] | Sequence modulation [symbol] | [symbol] |
| 2 [symbol] | 1-2 [symbol] | >2 [symbol] | CP-OFDM [symbol] | [symbol] |
| 3 [symbol] | 4-14 [symbol] | >2 [symbol] | DFT-s-OFDM [symbol] | [symbol] |
| | | | (no UE multiplexing) [symbol] | |
| 4 [symbol] | 4-14 [symbol] | >2 [symbol] | DFT-s-OFDM [symbol] | [symbol] |
| | | | (Pre DFT orthogonal cover | |
| | | | code(OCC)) [symbol] | |

The BS configures PUCCH resources for the UE by RRC signaling. For example, to allocate PUCCH resources, the BS may configure a plurality of PUCCH resource sets for the UE, and the UE may select a specific PUCCH resource set corresponding to a UCI (payload) size (e.g., the number of UCI bits). For example, the UE may select one of the following PUCCH resource sets according to the number of UCI bits, N_{UCI}.
PUCCH resource set #0, if the number of UCI bits≤2
PUCCH resource set #1, if 2<the number of UCI bits≤N₁

. . .
PUCCH resource set #(K-1), if NK-2<the number of UCI bits<N_{K-1}

Herein, K represents the number of PUCCH resource sets (K>1), and Ni represents the maximum number of UCI bits supported by PUCCH resource set #i. For example, PUCCH resource set #1 may include resources of PUCCH format 0 to PUCCH format 1, and the other PUCCH resource sets may include resources of PUCCH format 2 to PUCCH format 4.

Subsequently, the BS may transmit DCI to the UE on a PDCCH, indicating a PUCCH resource to be used for UCI transmission among the PUCCH resources of a specific PUCCH resource set by an ACK/NACK resource indicator (ARI) in the DCI. The ARI may be used to indicate a PUCCH resource for HARQ-ACK transmission, also called a PUCCH resource indicator (PRI).

### Enhanced Mobile Broadband Communication (eMBB)

In the NR system, a massive MIMO environment in which the number of Tx/Rx antennas is significantly increased is under consideration. On the other hand, in an NR system operating at or above 6 GHz, beamforming is considered, in which a signal is transmitted with concentrated energy in a specific direction, not omni-directionally, to compensate for rapid propagation attenuation. Accordingly, there is a need for hybrid beamforming with analog beamforming and digital beamforming in combination according to a position to which a beamforming weight vector/precoding vector is applied, for the purpose of increased performance, flexible resource allocation, and easiness of frequency-wise beam control.

### Hybrid Beamforming

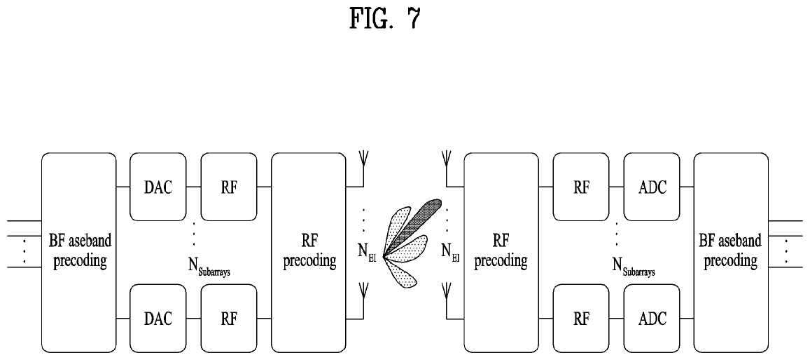

FIG. 7 is a block diagram illustrating an exemplary transmitter and receiver for hybrid beamforming.

In hybrid beamforming, a BS or a UE may form a narrow beam by transmitting the same signal through multiple antennas, using an appropriate phase difference and thus increasing energy only in a specific direction.

### Beam Management (BM)

BM is a series of processes for acquiring and maintaining a set of BS (or transmission and reception point (TRP)) beams and/or UE beams available for DL and UL transmissions/receptions. BM may include the following processes and terminology.

Beam measurement: the BS or the UE measures the characteristics of a received beamformed signal.
Beam determination: the BS or the UE selects its Tx beam/Rx beam.
Beam sweeping: a spatial domain is covered by using a Tx beam and/or an Rx beam in a predetermined method for a predetermined time interval.
Beam report: the UE reports information about a signal beamformed based on a beam measurement.

The BM procedure may be divided into (1) a DL BM procedure using an SSB or CSI-RS and (2) a UL BM procedure using an SRS. Further, each BM procedure may include Tx beam sweeping for determining a Tx beam and Rx beam sweeping for determining an Rx beam. The following description will focus on the DL BM procedure using an SSB.

The DL BM procedure using an SSB may include (1) transmission of a beamformed SSB from the BS and (2) beam reporting of the UE. An SSB may be used for both of Tx beam sweeping and Rx beam sweeping. SSB-based Rx beam sweeping may be performed by attempting SSB reception while changing Rx beams at the UE.

SSB-based beam reporting may be configured, when CSI/beam is configured in the RRC_CONNECTED state.
The UE receives information about an SSB resource set used for BM from the BS. The SSB resource set may be configured with one or more SSBIs. For each SSB resource set, SSBI 0 to SSBI 63 may be defined.
The UE receives signals in SSB resources from the BS based on the information about the SSB resource set.
When the BS configures the UE with an SSBRI and RSRP reporting, the UE reports a (best) SSBRI and an RSRP corresponding to the SSBRI to the BS.

The BS may determine a BS Tx beam for use in DL transmission to the UE based on a beam report received from the UE.

### Beam Failure Recovery (BFR) Procedure

In a beamforming system, radio link failure (RLF) may often occur due to rotation or movement of a UE or beamforming blockage. Therefore, BFR is supported to prevent frequent occurrence of RLF in NR.

For beam failure detection, the BS configures beam failure detection RSs for the UE. If the number of beam failure indications from the physical layer of the UE reaches a threshold configured by RRC signaling within a period configured by RRC signaling of the BS, the UE declares beam failure.

After the beam failure is detected, the UE triggers BFR by initiating a RACH procedure on a Pcell, and performs BFR by selecting a suitable beam (if the BS provides dedicated RACH resources for certain beams, the UE performs the RACH procedure for BFR by using the dedicated RACH resources first of all). Upon completion of the RACH procedure, the UE considers that the BFR has been completed.

### Ultra-Reliable and Low Latency Communication (URLLC)

A URLLC transmission defined in NR may mean a transmission with (1) a relatively small traffic size, (2) a relatively low arrival rate, (3) an extremely low latency requirement (e.g., 0.5 ms or 1 ms), (4) a relatively short transmission duration (e.g., 2 OFDM symbols), and (5) an emergency service/message.

### Pre-Emption Indication

Although eMBB and URLLC services may be scheduled in non-overlapped time/frequency resources, a URLLC transmission may take place in resources scheduled for on-going eMBB traffic. To enable a UE receiving a PDSCH to determine that the PDSCH has been partially punctured due to URLLC transmission of another UE, a preemption indication may be used. The preemption indication may also be referred to as an interrupted transmission indication.

In relation to a preemption indication, the UE receives DL preemption RRC information (e.g., a DownlinkPreemption IE) from the BS by RRC signaling.

The UE receives DCI format 2_1 based on the DL preemption RRC information from the BS. For example, the UE attempts to detect a PDCCH conveying preemption indication-related DCI, DCI format 2_1 by using an int-RNTI configured by the DL preemption RRC information.

Upon detection of DCI format 2_1 for serving cell(s) configured by the DL preemption RRC information, the UE may assume that there is no transmission directed to the UE in RBs and symbols indicated by DCI format 2_1 in a set of RBs and a set of symbols during a monitoring interval shortly previous to a monitoring interval to which DCI format 2_1 belongs. For example, the UE decodes data based on signals received in the remaining resource areas, considering that a signal in a time-frequency resource indicated by a preemption indication is not a DL transmission scheduled for the UE.

### Massive MTC (mMTC)

mMTC is one of 5G scenarios for supporting a hyper-connectivity service in which communication is conducted with multiple UEs at the same time. In this environment, a UE intermittently communicates at a very low transmission rate with low mobility. Accordingly, mMTC mainly seeks long operation of a UE with low cost. In this regard, MTC and narrow band-Internet of things (NB-IoT) handled in the 3GPP will be described below.

The following description is given with the appreciation that a transmission time interval (TTI) of a physical channel is a subframe. For example, a minimum time interval between the start of transmission of a physical channel and the start of transmission of the next physical channel is one subframe. However, a subframe may be replaced with a slot, a mini-slot, or multiple slots in the following description.

### Machine Type Communication (MTC)

MTC is an application that does not require high throughput, applicable to machine-to-machine (M2M) or IoT. MTC is a communication technology which the 3GPP has adopted to satisfy the requirements of the IoT service.

While the following description is given mainly of features related to enhanced MTC (eMTC), the same thing is applicable to MTC, eMTC, and MTC to be applied to 5G (or NR), unless otherwise mentioned. The term MTC as used herein may be interchangeable with eMTC, LTE-M1/M2, bandwidth reduced low complexity (BL)/coverage enhanced (CE), non-BL UE (in enhanced coverage), NR MTC, enhanced BL/CE, and so on.

### MTC General

(1) MTC operates only in a specific system BW (or channel BW).

MTC may use a predetermined number of RBs among the RBs of a system band in the legacy LTE system or the NR system. The operating frequency BW of MTC may be defined in consideration of a frequency range and a subcarrier spacing in NR. A specific system or frequency BW in which MTC operates is referred to as an MTC narrowband (NB) or MTC subband. In NR, MTC may operate in at least one BWP or a specific band of a BWP.

While MTC is supported by a cell having a much larger BW (e.g., 10 MHz) than 1.08 MHz, a physical channel and signal transmitted/received in MTC is always limited to 1.08 MHz or 6 (LTE) RBs. For example, a narrowband is defined as 6 non-overlapped consecutive physical resource blocks (PRBs) in the frequency domain in the LTE system.

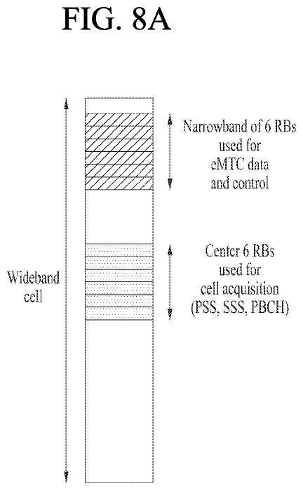

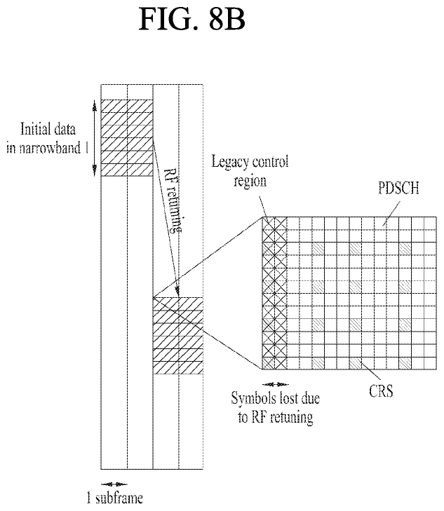

In MTC, some DL and UL channels are allocated restrictively within a narrowband, and one channel does not occupy a plurality of narrowbands in one time unit. FIG. 8A is a diagram illustrating an exemplary narrowband operation, and FIG. 8B is a diagram illustrating exemplary MTC channel repetition with RF retuning.

An MTC narrowband may be configured for a UE by system information or DCI transmitted by a BS.

(2) MTC does not use a channel (defined in legacy LTE or NR) which is to be distributed across the total system BW of the legacy LTE or NR. For example, because a legacy LTE PDCCH is distributed across the total system BW, the legacy PDCCH is not used in MTC. Instead, a new control channel, MTC PDCCH (MPDCCH) is used in MTC. The MPDCCH is transmitted/received in up to 6 RBs in the frequency domain. In the time domain, the MPDCCH may be transmitted in one or more OFDM symbols starting with an OFDM symbol of a starting OFDM symbol index indicated by an RRC parameter from the BS among the OFDM symbols of a subframe.

(3) In MTC, PBCH, PRACH, MPDCCH, PDSCH, PUCCH, and PUSCH may be transmitted repeatedly. The MTC repeated transmissions may make these channels decodable even when signal quality or power is very poor as in a harsh condition like basement, thereby leading to the effect of an increased cell radius and signal penetration.

### MTC Operation Modes and Levels

For CE, two operation modes, CE Mode A and CE Mode B and four different CE levels are used in MTC, as listed in [Table 2] below.

TABLE 2

| Mode [symbol] | Level [symbol] | Description [symbol] | [symbol] |
|---|---|---|---|
| Mode A [symbol] | Level 1 [symbol] | No repetition for PRACH [symbol] | [symbol] |
| | Level 2 [symbol] | Small Number of Repetition for PRACH [symbol] | [symbol] |
| Mode B [symbol] | Level 3 [symbol] | Medium Number of Repetition | [symbol] |
| | | for PRACH [symbol] | |
| | Level 4 [symbol] | Large Number of Repetition for PRACH [symbol] | [symbol] |

An MTC operation mode is determined by a BS and a CE level is determined by an MTC UE.

### MTC Guard Period

The position of a narrowband used for MTC may change in each specific time unit (e.g., subframe or slot). An MTC UE may tune to different frequencies in different time units. A certain time may be required for frequency retuning and thus used as a guard period for MTC. No transmission and reception take place during the guard period.

### MTC Signal Transmission/Reception Method

Apart from features inherent to MTC, an MTC signal transmission/reception procedure is similar to the procedure illustrated in FIG. 2. The operation of S201 in FIG. 2 may also be performed for MTC. A PSS/SSS used in an initial cell search operation in MTC may be the legacy LTE PSS/SSS.

After acquiring synchronization with a BS by using the PSS/SSS, an MTC UE may acquire broadcast information within a cell by receiving a PBCH signal from the BS. The broadcast information transmitted on the PBCH is an MIB. In MTC, reserved bits among the bits of the legacy LTE MIB are used to transmit scheduling information for a new system information block 1 bandwidth reduced (SIB1-BR). The scheduling information for the SIB1-BR may include information about a repetition number and a TBS for a PDSCH conveying SIB1-BR. A frequency resource assignment for the PDSCH conveying SIB-BR may be a set of 6 consecutive RBs within a narrowband. The SIB-BR is transmitted directly on the PDSCH without a control channel (e.g., PDCCH or MPDCCH) associated with SIB-BR.

After completing the initial cell search, the MTC UE may acquire more specific system information by receiving an MPDCCH and a PDSCH based on information of the MPDCCH (S202).

Subsequently, the MTC UE may perform a RACH procedure to complete connection to the BS (S203 to S206). A basic configuration for the RACH procedure of the MTC UE may be transmitted in SIB2. Further, SIB2 includes paging-related parameters. In the 3GPP system, a paging occasion (PO) means a time unit in which a UE may attempt to receive paging. Paging refers to the network's indication of the presence of data to be transmitted to the UE. The MTC UE attempts to receive an MPDCCH based on a P-RNTI in a time unit corresponding to its PO in a narrowband configured for paging, paging narrowband (PNB). When the UE succeeds in decoding the MPDCCH based on the P-RNTI, the UE may check its paging message by receiving a PDSCH scheduled by the MPDCCH. In the presence of its paging message, the UE accesses the network by performing the RACH procedure.

In MTC, signals and/or messages (Msg1, Msg2, Msg3, and Msg4) may be transmitted repeatedly in the RACH procedure, and a different repetition pattern may be set according to a CE level.

For random access, PRACH resources for different CE levels are signaled by the BS. Different PRACH resources for up to 4 respective CE levels may be signaled to the MTC UE. The MTC UE measures an RSRP using a DL RS (e.g., CRS, CSI-RS, or TRS) and determines one of the CE levels signaled by the BS based on the measurement. The UE selects one of different PRACH resources (e.g., frequency, time, and preamble resources for a PARCH) for random access based on the determined CE level and transmits a PRACH. The BS may determine the CE level of the UE based on the PRACH resources that the UE has used for the PRACH transmission. The BS may determine a CE mode for the UE based on the CE level that the UE indicates by the PRACH transmission. The BS may transmit DCI to the UE in the CE mode.

Search spaces for an RAR for the PRACH and contention resolution messages are signaled in system information by the BS.

After the above procedure, the MTC UE may receive an MPDCCH signal and/or a PDSCH signal (S207) and transmit a PUSCH signal and/or a PUCCH signal (S208) in a general UL/DL signal transmission procedure. The MTC UE may transmit UCI on a PUCCH or a PUSCH to the BS.

Once an RRC connection for the MTC UE is established, the MTC UE attempts to receive an MDCCH by monitoring an MPDCCH in a configured search space in order to acquire UL and DL data allocations.

In legacy LTE, a PDSCH is scheduled by a PDCCH. Specifically, the PDCCH may be transmitted in the first N (N=1, 2 or 3) OFDM symbols of a subframe, and the PDSCH scheduled by the PDCCH is transmitted in the same subframe.

Compared to legacy LTE, an MPDCCH and a PDSCH scheduled by the MPDCCH are transmitted/received in different subframes in MTC. For example, an MPDCCH with a last repetition in subframe #n schedules a PDSCH starting in subframe #n+2. The MPDCCH may be transmitted only once or repeatedly. A maximum repetition number of the MPDCCH is configured for the UE by RRC signaling from the BS. DCI carried on the MPDCCH provides information on how many times the MPDCCH is repeated so that the UE may determine when the PDSCH transmission starts. For example, if DCI in an MPDCCH starting in subframe #n includes information indicating that the MPDCCH is repeated 10 times, the MPDCCH may end in subframe #n+9 and the PDSCH may start in subframe #n+11. The DCI carried on the MPDCCH may include information about a repetition number for a physical data channel (e.g., PUSCH or PDSCH) scheduled by the DCI. The UE may transmit/receive the physical data channel repeatedly in the time domain according to the information about the repetition number of the physical data channel scheduled by the DCI. The PDSCH may be scheduled in the same or different narrowband as or from a narrowband in which the MPDCCH scheduling the PDSCH is transmitted. When the MPDCCH and the PDSCH are in different narrowbands, the MTC UE needs to retune to the frequency of the narrowband carrying the PDSCH before decoding the PDSCH. For UL scheduling, the same timing as in legacy LTE may be followed. For example, an MPDCCH ending in subframe #n may schedule a PUSCH transmission starting in subframe #n+4. If a physical channel is repeatedly transmitted, frequency hopping is supported between different MTC subbands by RF retuning. For example, if a PDSCH is repeatedly transmitted in 32 subframes, the PDSCH is transmitted in the first 16 subframes in a first MTC subband, and in the remaining 16 subframes in a second MTC subband. MTC may operate in half-duplex mode.

### Narrowband-Internet of Things (NB-IoT)

NB-IoT may refer to a system for supporting low complexity, low power consumption, and efficient use of frequency resources by a system BW corresponding to one RB of a wireless communication system (e.g., the LTE system or the NR system). NB-IoT may operate in half-duplex mode. NB-IoT may be used as a communication scheme for implementing IoT by supporting, for example, an MTC device (or UE) in a cellular system.

In NB-IoT, each UE perceives one RB as one carrier. Therefore, an RB and a carrier as mentioned in relation to NB-IoT may be interpreted as the same meaning.

While a frame structure, physical channels, multi-carrier operations, and general signal transmission/reception in relation to NB-IoT will be described below in the context of the legacy LTE system, the description is also applicable to the next generation system (e.g., the NR system). Further, the description of NB-IoT may also be applied to MTC serving similar technical purposes (e.g., low power, low cost, and coverage enhancement).

### NB-IoT Frame Structure and Physical Resources

A different NB-IoT frame structure may be configured according to a subcarrier spacing. For example, for a subcarrier spacing of 15 kHz, the NB-IoT frame structure may be identical to that of a legacy system (e.g., the LTE system). For example, a 10-ms NB-IoT frame may include 10 1-ms NB-IoT subframes each including two 0.5-ms slots. Each 0.5-ms NB-IoT slot may include 7 OFDM symbols. In another example, for a BWP or cell/carrier having a subcarrier spacing of 3.75 kHz, a 10-ms NB-IoT frame may include five 2-ms NB-IoT subframes each including 7 OFDM symbols and one guard period (GP). Further, a 2-ms NB-IoT subframe may be represented in NB-IoT slots or NB-IoT resource units (RUs). The NB-IoT frame structures are not limited to the subcarrier spacings of 15 kHz and 3.75 kHz, and NB-IoT for other subcarrier spacings (e.g., 30 kHz) may also be considered by changing time/frequency units.

NB-IoT DL physical resources may be configured based on physical resources of other wireless communication systems (e.g., the LTE system or the NR system) except that a system BW is limited to a predetermined number of RBs (e.g., one RB, that is, 180 kHz). For example, if the NB-IoT DL supports only the 15-kHz subcarrier spacing as described before, the NB-IoT DL physical resources may be configured as a resource area in which the resource grid illustrated in FIG. 1 is limited to one RB in the frequency domain.

Like the NB-IoT DL physical resources, NB-IoT UL resources may also be configured by limiting a system BW to one RB. In NB-IoT, the number of UL subcarriers N^{UL}sc and a slot duration Tₛₗₒₜ may be given as illustrated in [Table 3] below. In NB-IoT of the LTE system, the duration of one slot, Tₛₗₒₜ is defined by 7 SC-FDMA symbols in the time domain.

TABLE 3

| Subcarrier | | | |
|---|---|---|---|
| spacing [symbol] | N^{UL}_{sc} [symbol] | Tₛₗₒₜ [symbol] | [symbol] |
| Δf = 3.75 kHz [symbol] | 48 [symbol] | 6144 · Tₛ [symbol] | [symbol] |
| Δf = 15 kHz [symbol] | 12 [symbol] | 15360 · Tₛ [symbol] | [symbol] |

In NB-IoT, RUs are used for mapping to REs of a PUSCH for NB-IoT (referred to as an NPUSCH). An RU may be defined by N^{UL}symb*N^{UL}slot SC-FDMA symbols in the time domain by N^{RU}sc consecutive subcarriers in the frequency domain. For example, N^{RU}sc and N^{UL}symb are listed in [Table 4] for a cell/carrier having an FDD frame structure and in [Table 5] for a cell/carrier having a TDD frame structure.

TABLE 4

| NPUSCH format [symbol] | Δf [symbol] | N^{RU}_{sc} [symbol] | N^{UL}ₛₗₒₜ [symbol] | N^{UL}_{symb} [symbol] | [symbol] |
|---|---|---|---|---|---|
| 1 [symbol] | 3.75 kHz [symbol] | 1 [symbol] | 16 [symbol] | 7 [symbol] | [symbol] |
| | 15 kHz [symbol] | 1 [symbol] | 16 [symbol] | | [symbol] |
| | | 3 [symbol] | 8 [symbol] | | [symbol] |
| | | 6 [symbol] | 4 [symbol] | | [symbol] |
| | | 12 [symbol] | 2 [symbol] | | [symbol] |
| 2 [symbol] | 3.75 kHz [symbol] | 1 [symbol] | 4 [symbol] | | [symbol] |
| | 15 kHz [symbol] | 1 [symbol] | 4 [symbol] | | [symbol] |

TABLE 5

| NPUSCH | | Supported uplink-downlink | | | | |
|---|---|---|---|---|---|---|
| format [symbol] | Δf [symbol] | configurations [symbol] | N^{RU}_{sc} [symbol] | N^{UL}ₛₗₒₜ [symbol] | N^{UL}_{symb} [symbol] | [symbol] |
| 1 [symbol] | 3.75 kHz [symbol] | 1, 4 [symbol] | 1 [symbol] | 16 [symbol] | 7 [symbol] | [symbol] |
| | 15 kHz [symbol] | 1, 2, 3, | 1 [symbol] | 16 [symbol] | | [symbol] |
| | | 4, 5 [symbol] | 3 [symbol] | 8 [symbol] | | [symbol] |
| | | | 6 [symbol] | 4 [symbol] | | [symbol] |
| | | | 12 [symbol] | 2 [symbol] | | [symbol] |
| 2 [symbol] | 3.75 kHz [symbol] | 1, 4 [symbol] | 1 [symbol] | 4 [symbol] | | [symbol] |
| | 15 kHz [symbol] | 1, 2, 3, | 1 [symbol] | 4 [symbol] | | [symbol] |
| | | 4, 5 [symbol] | | | | |

### NB-IoT Physical Channels

OFDMA may be adopted for NB-IoT DL based on the 15-kHz subcarrier spacing. Because OFDMA provides orthogonality between subcarriers, co-existence with other systems (e.g., the LTE system or the NR system) may be supported efficiently. The names of DL physical channels/signals of the NB-IoT system may be prefixed with “N (narrowband)” to be distinguished from their counterparts in the legacy system. For example, DL physical channels may be named NPBCH, NPDCCH, NPDSCH, and so on, and DL physical signals may be named NPSS, NSSS, narrowband reference signal (NRS), narrowband positioning reference signal (NPRS), narrowband wake up signal (NWUS), and so on. The DL channels, NPBCH, NPDCCH, NPDSCH, and so on may be repeatedly transmitted to enhance coverage in the NB-IoT system. Further, new defined DCI formats may be used in NB-IoT, such as DCI format NO, DCI format N1, and DCI format N2.

SC-FDMA may be applied with the 15-kHz or 3.75-kHz subcarrier spacing to NB-IoT UL. As described in relation to DL, the names of physical channels of the NB-IoT system may be prefixed with “N (narrowband)” to be distinguished from their counterparts in the legacy system. For example, UL channels may be named NPRACH, NPUSCH, and so on, and UL physical signals may be named NDMRS and so on. NPUSCHs may be classified into NPUSCH format 1 and NPUSCH format 2. For example, NPUSCH format 1 may be used to transmit (or deliver) an uplink shared channel (UL-SCH), and NPUSCH format 2 may be used for UCI transmission such as HARQ ACK signaling. A UL channel, NPRACH in the NB-IoT system may be repeatedly transmitted to enhance coverage. In this case, the repeated transmissions may be subjected to frequency hopping.

### Multi-Carrier Operation in NB-IoT

NB-IoT may be implemented in multi-carrier mode. A multi-carrier operation may refer to using multiple carriers configured for different usages (i.e., multiple carriers of different types) in transmitting/receiving channels and/or signals between a BS and a UE.

In the multi-carrier mode in NB-IoT, carriers may be divided into anchor type carrier (i.e., anchor carrier or anchor PRB) and non-anchor type carrier (i.e., non-anchor carrier or non-anchor PRB).

The anchor carrier may refer to a carrier carrying an NPSS, an NSSS, and an NPBCH for initial access, and an NPDSCH for a system information block, N-SIB from the perspective of a BS. That is, a carrier for initial access is referred to as an anchor carrier, and the other carrier(s) is referred to as a non-anchor carrier in NB-IoT.

### NB-IoT Signal Transmission/Reception Process

In NB-IoT, a signal is transmitted/received in a similar manner to the procedure illustrated in FIG. 2, except for features inherent to NB-IoT. Referring to FIG. 2, when an NB-IoT UE is powered on or enters a new cell, the NB-IoT UE may perform an initial cell search (S201). For the initial cell search, the NB-IoT UE may acquire synchronization with a BS and obtain information such as a cell ID by receiving an NPSS and an NSSS from the BS. Further, the NB-IoT UE may acquire broadcast information within a cell by receiving an NPBCH from the BS.

Upon completion of the initial cell search, the NB-IoT UE may acquire more specific system information by receiving an NPDCCH and receiving an NPDSCH corresponding to the NPDCCH (S202). In other words, the BS may transmit more specific system information to the NB-IoT UE which has completed the initial call search by transmitting an NPDCCH and an NPDSCH corresponding to the NPDCCH.

The NB-IoT UE may then perform a RACH procedure to complete a connection setup with the BS (S203 to S206). For this purpose, the NB-IoT UE may transmit a preamble on an NPRACH to the BS (S203). As described before, it may be configured that the NPRACH is repeatedly transmitted based on frequency hopping, for coverage enhancement. In other words, the BS may (repeatedly) receive the preamble on the NPRACH from the NB-IoT UE. The NB-IoT UE may then receive an NPDCCH, and a RAR in response to the preamble on an NPDSCH corresponding to the NPDCCH from the BS (S204). In other words, the BS may transmit the NPDCCH, and the RAR in response to the preamble on the NPDSCH corresponding to the NPDCCH to the NB-IoT UE. Subsequently, the NB-IoT UE may transmit an NPUSCH to the BS, using scheduling information in the RAR (S205) and perform a contention resolution procedure by receiving an NPDCCH and an NPDSCH corresponding to the NPDCCH (S206).

After the above process, the NB-IoT UE may perform an NPDCCH/NPDSCH reception (S207) and an NPUSCH transmission (S208) in a general UL/DL signal transmission procedure. In other words, after the above process, the BS may perform an NPDCCH/NPDSCH transmission and an NPUSCH reception with the NB-IoT UE in the general UL/DL signal transmission procedure.

In NB-IoT, the NPBCH, the NPDCCH, and the NPDSCH may be transmitted repeatedly, for coverage enhancement. A UL-SCH (i.e., general UL data) and UCI may be delivered on the PUSCH in NB-IoT. It may be configured that the UL-SCH and the UCI are transmitted in different NPUSCH formats (e.g., NPUSCH format 1 and NPUSCH format 2).

In NB-IoT, UCI may generally be transmitted on an NPUSCH. Further, the UE may transmit the NPUSCH periodically, aperiodically, or semi-persistently according to request/indication of the network (e.g., BS).

### Wireless Communication Apparatus

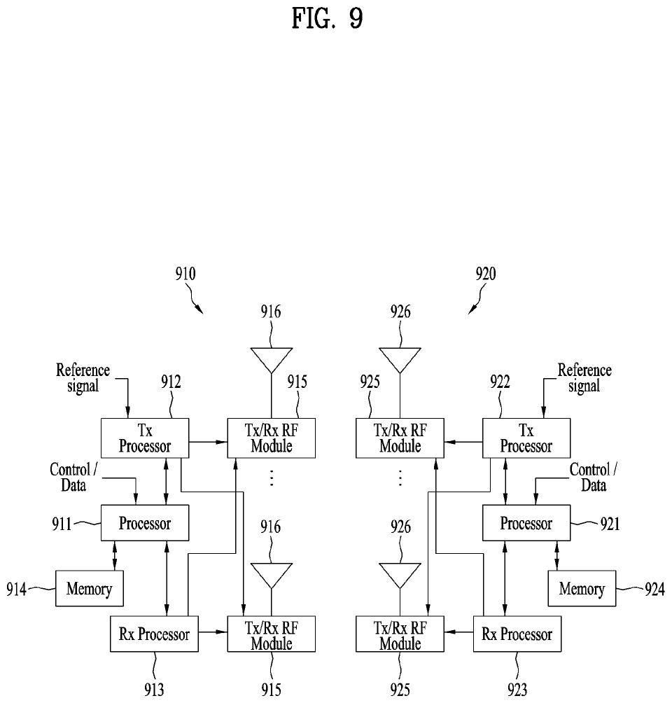

FIG. 9 is a block diagram of an exemplary wireless communication system to which proposed methods of the present disclosure are applicable.

Referring to FIG. 9, the wireless communication system includes a first communication device 910 and/or a second communication device 920. The phrases “A and/or B” and “at least one of A or B” are may be interpreted as the same meaning. The first communication device 910 may be a BS, and the second communication device 920 may be a UE (or the first communication device 910 may be a UE, and the second communication device 920 may be a BS).

Each of the first communication device 910 and the second communication device 920 includes a processor 911 or 921, a memory 914 or 924, one or more Tx/Rx RF modules 915 or 925, a Tx processor 912 or 922, an Rx processor 913 or 923, and antennas 916 or 926. A Tx/Rx module may also be called a transceiver. The processor performs the afore-described functions, processes, and/or methods. More specifically, on DL (communication from the first communication device 910 to the second communication device 920), a higher-layer packet from a core network is provided to the processor 911. The processor 911 implements Layer 2 (i.e., L2) functionalities. On DL, the processor 911 is responsible for multiplexing between a logical channel and a transport channel, provisioning of a radio resource assignment to the second communication device 920, and signaling to the second communication device 920. The Tx processor 912 executes various signal processing functions of L1 (i.e., the physical layer). The signal processing functions facilitate forward error correction (FEC) of the second communication device 920, including coding and interleaving. An encoded and interleaved signal is modulated to complex-valued modulation symbols after scrambling and modulation. For the modulation, BPSK, QPSK, 16 QAM, 64 QAM, 246 QAM, and so on are available according to channels. The complex-valued modulation symbols (hereinafter, referred to as modulation symbols) are divided into parallel streams. Each stream is mapped to OFDM subcarriers and multiplexed with an RS in the time and/or frequency domain. A physical channel is generated to carry a time-domain OFDM symbol stream by subjecting the mapped signals to IFFT. The OFDM symbol stream is spatially precoded to multiple spatial streams. Each spatial stream may be provided to a different antenna 916 through an individual Tx/Rx module (or transceiver) 915. Each Tx/Rx module 915 may upconvert the frequency of each spatial stream to an RF carrier, for transmission. In the second communication device 920, each Tx/Rx module (or transceiver) 925 receives a signal of the RF carrier through each antenna 926. Each Tx/Rx module 925 recovers the signal of the RF carrier to a baseband signal and provides the baseband signal to the Rx processor 923. The Rx processor 923 executes various signal processing functions of L1 (i.e., the physical layer). The Rx processor 923 may perform spatial processing on information to recover any spatial stream directed to the second communication device 920. If multiple spatial streams are directed to the second communication device 920, multiple Rx processors may combine the multiple spatial streams into a single OFDMA symbol stream. The Rx processor 923 converts an OFDM symbol stream being a time-domain signal to a frequency-domain signal by FFT. The frequency-domain signal includes an individual OFDM symbol stream on each subcarrier of an OFDM signal. Modulation symbols and an RS on each subcarrier are recovered and demodulated by determining most likely signal constellation points transmitted by the first communication device 910. These soft decisions may be based on channel estimates. The soft decisions are decoded and deinterleaved to recover the original data and control signal transmitted on physical channels by the first communication device 910. The data and control signal are provided to the processor 921.

On UL (communication from the second communication device 920 to the first communication device 910), the first communication device 910 operates in a similar manner as described in relation to the receiver function of the second communication device 920. Each Tx/Rx module 925 receives a signal through an antenna 926. Each Tx/Rx module 925 provides an RF carrier and information to the Rx processor 923. The processor 921 may be related to the memory 924 storing a program code and data. The memory 924 may be referred to as a computer-readable medium.

### Artificial Intelligence (AI)

Artificial intelligence is a field of studying AI or methodologies for creating AI, and machine learning is a field of defining various issues dealt with in the AI field and studying methodologies for addressing the various issues. Machine learning is defined as an algorithm that increases the performance of a certain operation through steady experiences for the operation.

An artificial neural network (ANN) is a model used in machine learning and may generically refer to a model having a problem-solving ability, which is composed of artificial neurons (nodes) forming a network via synaptic connections. The ANN may be defined by a connection pattern between neurons in different layers, a learning process for updating model parameters, and an activation function for generating an output value.

The ANN may include an input layer, an output layer, and optionally, one or more hidden layers. Each layer includes one or more neurons, and the ANN may include a synapse that links between neurons. In the ANN, each neuron may output the function value of the activation function, for the input of signals, weights, and deflections through the synapse.

Model parameters refer to parameters determined through learning and include a weight value of a synaptic connection and deflection of neurons. A hyperparameter means a parameter to be set in the machine learning algorithm before learning, and includes a learning rate, a repetition number, a mini batch size, and an initialization function.

The purpose of learning of the ANN may be to determine model parameters that minimize a loss function. The loss function may be used as an index to determine optimal model parameters in the learning process of the ANN.

Machine learning may be classified into supervised learning, unsupervised learning, and reinforcement learning according to learning methods.

Supervised learning may be a method of training an ANN in a state in which a label for training data is given, and the label may mean a correct answer (or result value) that the ANN should infer with respect to the input of training data to the ANN. Unsupervised learning may be a method of training an ANN in a state in which a label for training data is not given. Reinforcement learning may be a learning method in which an agent defined in a certain environment is trained to select a behavior or a behavior sequence that maximizes cumulative compensation in each state.

Machine learning, which is implemented by a deep neural network (DNN) including a plurality of hidden layers among ANNs, is also referred to as deep learning, and deep learning is part of machine learning. The following description is given with the appreciation that machine learning includes deep learning.

<Robot>

A robot may refer to a machine that automatically processes or executes a given task by its own capabilities. Particularly, a robot equipped with a function of recognizing an environment and performing an operation based on its decision may be referred to as an intelligent robot.

Robots may be classified into industrial robots, medical robots, consumer robots, military robots, and so on according to their usages or application fields.

A robot may be provided with a driving unit including an actuator or a motor, and thus perform various physical operations such as moving robot joints. Further, a movable robot may include a wheel, a brake, a propeller, and the like in a driving unit, and thus travel on the ground or fly in the air through the driving unit.

<Self-Driving>

Self-driving refers to autonomous driving, and a self-driving vehicle refers to a vehicle that travels with no user manipulation or minimum user manipulation.

For example, self-driving may include a technology of maintaining a lane while driving, a technology of automatically adjusting a speed, such as adaptive cruise control, a technology of automatically traveling along a predetermined route, and a technology of automatically setting a route and traveling along the route when a destination is set.

Vehicles may include a vehicle having only an internal combustion engine, a hybrid vehicle having both an internal combustion engine and an electric motor, and an electric vehicle having only an electric motor, and may include not only an automobile but also a train, a motorcycle, and the like.

Herein, a self-driving vehicle may be regarded as a robot having a self-driving function.

<eXtended Reality (XR)>

Extended reality is a generical term covering virtual reality (VR), augmented reality (AR), and mixed reality (MR). VR provides a real-world object and background only as a computer graphic (CG) image, AR provides a virtual CG image on a real object image, and MR is a computer graphic technology that mixes and combines virtual objects into the real world.

MR is similar to AR in that the real object and the virtual object are shown together. However, in AR, the virtual object is used as a complement to the real object, whereas in MR, the virtual object and the real object are handled equally.

XR may be applied to a head-mounted display (HMD), a head-up display (HUD), a portable phone, a tablet PC, a laptop computer, a desktop computer, a TV, a digital signage, and so on. A device to which XR is applied may be referred to as an XR device.

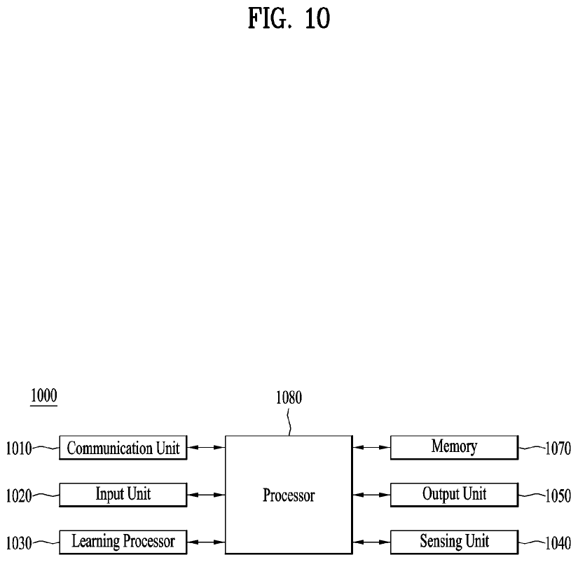

FIG. 10 illustrates an AI device 1000 according to an embodiment of the present disclosure.

The AI device 1000 illustrated in FIG. 10 may be configured as a stationary device or a mobile device, such as a TV, a projector, a portable phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a digital multimedia broadcasting (DMB) receiver, a radio, a washing machine, a refrigerator, a digital signage, a robot, or a vehicle.

Referring to FIG. 10, the AI device 1000 may include a communication unit 1010, an input unit 1020, a learning processor 1030, a sensing unit 1040, an output unit 1050, a memory 1070, and a processor 1080.

The communication unit 1010 may transmit and receive data to and from an external device such as another AI device or an AI server by wired or wireless communication. For example, the communication unit 1010 may transmit and receive sensor information, a user input, a learning model, and a control signal to and from the external device.

Communication schemes used by the communication unit 1010 include global system for mobile communication (GSM), CDMA, LTE, 5G, wireless local area network (WLAN), wireless fidelity (Wi-Fi), Bluetooth™, radio frequency identification (RFID), infrared data association (IrDA), ZigBee, near field communication (NFC), and so on. Particularly, the 5G technology described before with reference to FIGS. 1 to 9 may also be applied.

The input unit 1020 may acquire various types of data. The input unit 1020 may include a camera for inputting a video signal, a microphone for receiving an audio signal, and a user input unit for receiving information from a user. The camera or the microphone may be treated as a sensor, and thus a signal acquired from the camera or the microphone may be referred to as sensing data or sensor information.

The input unit 1020 may acquire training data for model training and input data to be used to acquire an output by using a learning model. The input unit 1020 may acquire raw input data. In this case, the processor 1080 or the learning processor 1030 may extract an input feature by preprocessing the input data.

The learning processor 1030 may train a model composed of an ANN by using training data. The trained ANN may be referred to as a learning model. The learning model may be used to infer a result value for new input data, not training data, and the inferred value may be used as a basis for determination to perform a certain operation.

The learning processor 1030 may perform AI processing together with a learning processor of an AI server.

The learning processor 1030 may include a memory integrated or implemented in the AI device 1000. Alternatively, the learning processor 1030 may be implemented by using the memory 1070, an external memory directly connected to the AI device 1000, or a memory maintained in an external device.

The sensing unit 1040 may acquire at least one of internal information about the AI device 1000, ambient environment information about the AI device 1000, and user information by using various sensors.

The sensors included in the sensing unit 1040 may include a proximity sensor, an illumination sensor, an accelerator sensor, a magnetic sensor, a gyro sensor, an inertial sensor, a red, green, blue (RGB) sensor, an IR sensor, a fingerprint recognition sensor, an ultrasonic sensor, an optical sensor, a microphone, a light detection and ranging (LiDAR), and a radar.

The output unit 1050 may generate a visual, auditory, or haptic output.

Accordingly, the output unit 1050 may include a display unit for outputting visual information, a speaker for outputting auditory information, and a haptic module for outputting haptic information.

The memory 1070 may store data that supports various functions of the AI device 1000. For example, the memory 1070 may store input data acquired by the input unit 1020, training data, a learning model, a learning history, and so on.

The processor 1080 may determine at least one executable operation of the AI device 100 based on information determined or generated by a data analysis algorithm or a machine learning algorithm. The processor 1080 may control the components of the AI device 1000 to execute the determined operation.

To this end, the processor 1080 may request, search, receive, or utilize data of the learning processor 1030 or the memory 1070. The processor 1080 may control the components of the AI device 1000 to execute a predicted operation or an operation determined to be desirable among the at least one executable operation.

When the determined operation needs to be performed in conjunction with an external device, the processor 1080 may generate a control signal for controlling the external device and transmit the generated control signal to the external device.

The processor 1080 may acquire intention information with respect to a user input and determine the user's requirements based on the acquired intention information.

The processor 1080 may acquire the intention information corresponding to the user input by using at least one of a speech to text (STT) engine for converting a speech input into a text string or a natural language processing (NLP) engine for acquiring intention information of a natural language.

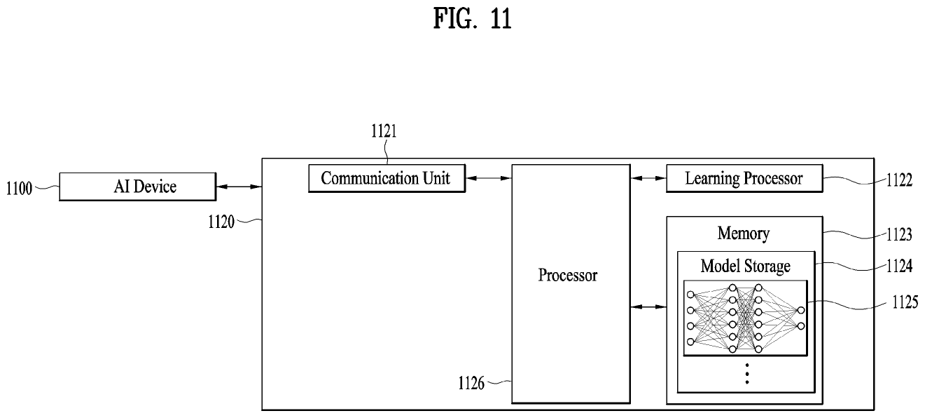

At least one of the STT engine or the NLP engine may be configured as an ANN, at least part of which is trained according to the machine learning algorithm. At least one of the STT engine or the NLP engine may be trained by the learning processor, a learning processor of the AI server, or distributed processing of the learning processors. For reference, specific components of the AI server are illustrated in FIG. 11.

The processor 1080 may collect history information including the operation contents of the AI device 1000 or the user's feedback on the operation and may store the collected history information in the memory 1070 or the learning processor 1030 or transmit the collected history information to the external device such as the AI server. The collected history information may be used to update the learning model.

The processor 1080 may control at least a part of the components of AI device 1000 so as to drive an application program stored in the memory 1070. Furthermore, the processor 1080 may operate two or more of the components included in the AI device 1000 in combination so as to drive the application program.

FIG. 11 illustrates an AI server 1120 according to an embodiment of the present disclosure.

Referring to FIG. 11, the AI server 1120 may refer to a device that trains an ANN by a machine learning algorithm or uses a trained ANN. The AI server 1120 may include a plurality of servers to perform distributed processing, or may be defined as a 5G network. The AI server 1120 may be included as part of the AI device 1100, and perform at least part of the AI processing.

The AI server 1120 may include a communication unit 1121, a memory 1123, a learning processor 1122, a processor 1126, and so on.

The communication unit 1121 may transmit and receive data to and from an external device such as the AI device 1100.

The memory 1123 may include a model storage 1124. The model storage 1124 may store a model (or an ANN 1125) which has been trained or is being trained through the learning processor 1122.

The learning processor 1122 may train the ANN 1125 by training data. The learning model may be used, while being loaded on the AI server 1120 of the ANN, or on an external device such as the AI device 1110.

The learning model may be implemented in hardware, software, or a combination of hardware and software. If all or part of the learning model is implemented in software, one or more instructions of the learning model may be stored in the memory 1123.

The processor 1126 may infer a result value for new input data by using the learning model and may generate a response or a control command based on the inferred result value.

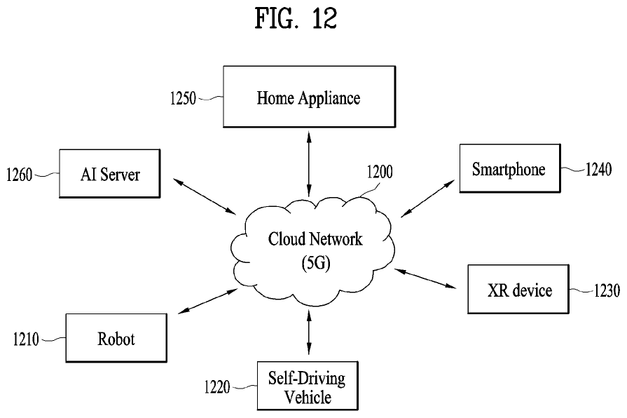

FIG. 12 illustrates an AI system according to an embodiment of the present disclosure.

Referring to FIG. 12, in the AI system, at least one of an AI server 1260, a robot 1210, a self-driving vehicle 1220, an XR device 1230, a smartphone 1240, or a home appliance 1250 is connected to a cloud network 1200. The robot 1210, the self-driving vehicle 1220, the XR device 1230, the smartphone 1240, or the home appliance 1250, to which AI is applied, may be referred to as an AI device.

The cloud network 1200 may refer to a network that forms part of cloud computing infrastructure or exists in the cloud computing infrastructure. The cloud network 1200 may be configured by using a 3G network, a 4G or LTE network, or a 5G network.

That is, the devices 1210 to 1260 included in the AI system may be interconnected via the cloud network 1200. In particular, each of the devices 1210 to 1260 may communicate with each other directly or through a BS.

The AI server 1260 may include a server that performs AI processing and a server that performs computation on big data.

The AI server 1260 may be connected to at least one of the AI devices included in the AI system, that is, at least one of the robot 1210, the self-driving vehicle 1220, the XR device 1230, the smartphone 1240, or the home appliance 1250 via the cloud network 1200, and may assist at least part of AI processing of the connected AI devices 1210 to 1250.

The AI server 1260 may train the ANN according to the machine learning algorithm on behalf of the AI devices 1210 to 1250, and may directly store the learning model or transmit the learning model to the AI devices 1210 to 1250.

The AI server 1260 may receive input data from the AI devices 1210 to 1250, infer a result value for received input data by using the learning model, generate a response or a control command based on the inferred result value, and transmit the response or the control command to the AI devices 1210 to 1250.

Alternatively, the AI devices 1210 to 1250 may infer the result value for the input data by directly using the learning model, and generate the response or the control command based on the inference result.

Hereinafter, various embodiments of the AI devices 1210 to 1250 to which the above-described technology is applied will be described. The AI devices 1210 to 1250 illustrated in FIG. 12 may be regarded as a specific embodiment of the AI device 1000 illustrated in FIG. 10.

<AI+XR>

The XR device 1230, to which AI is applied, may be configured as a HMD, a HUD provided in a vehicle, a TV, a portable phone, a smartphone, a computer, a wearable device, a home appliance, a digital signage, a vehicle, a fixed robot, a mobile robot, or the like.

The XR device 1230 may acquire information about a surrounding space or a real object by analyzing 3D point cloud data or image data acquired from various sensors or an external device and thus generating position data and attribute data for the 3D points, and may render an XR object to be output. For example, the XR device 1230 may output an XR object including additional information about a recognized object in correspondence with the recognized object.

The XR device 1230 may perform the above-described operations by using the learning model composed of at least one ANN. For example, the XR device 1230 may recognize a real object from 3D point cloud data or image data by using the learning model, and may provide information corresponding to the recognized real object. The learning model may be trained directly by the XR device 1230 or by the external device such as the AI server 1260.

While the XR device 1230 may operate by generating a result by directly using the learning model, the XR device 1230 may operate by transmitting sensor information to the external device such as the AI server 1260 and receiving the result.

<AI+Robot+XR>

The robot 1210, to which AI and XR are applied, may be implemented as a guide robot, a delivery robot, a cleaning robot, a wearable robot, an entertainment robot, a pet robot, an unmanned flying robot, a drone, or the like.

The robot 1210, to which XR is applied, may refer to a robot to be controlled/interact within an XR image. In this case, the robot 1210 may be distinguished from the XR device 1230 and interwork with the XR device 1230.

When the robot 1210 to be controlled/interact within an XR image acquires sensor information from sensors each including a camera, the robot 1210 or the XR device 1230 may generate an XR image based on the sensor information, and the XR device 1230 may output the generated XR image. The robot 1210 may operate based on the control signal received through the XR device 1230 or based on the user's interaction.

For example, the user may check an XR image corresponding to a view of the robot 1210 interworking remotely through an external device such as the XR device 1210, adjust a self-driving route of the robot 1210 through interaction, control the operation or driving of the robot 1210, or check information about an ambient object around the robot 1210.

<AI+Self-Driving+XR>

The self-driving vehicle 1220, to which AI and XR are applied, may be implemented as a mobile robot, a vehicle, an unmanned flying vehicle, or the like.

The self-driving driving vehicle 1220, to which XR is applied, may refer to a self-driving vehicle provided with a means for providing an XR image or a self-driving vehicle to be controlled/interact within an XR image. Particularly, the self-driving vehicle 1220 to be controlled/interact within an XR image may be distinguished from the XR device 1230 and interwork with the XR device 1230.

The self-driving vehicle 1220 provided with the means for providing an XR image may acquire sensor information from the sensors each including a camera and output the generated XR image based on the acquired sensor information. For example, the self-driving vehicle 1220 may include an HUD to output an XR image, thereby providing a passenger with an XR object corresponding to a real object or an object on the screen.

When the XR object is output to the HUD, at least part of the XR object may be output to be overlaid on an actual object to which the passenger's gaze is directed. When the XR object is output to a display provided in the self-driving vehicle 1220, at least part of the XR object may be output to be overlaid on the object within the screen. For example, the self-driving vehicle 1220 may output XR objects corresponding to objects such as a lane, another vehicle, a traffic light, a traffic sign, a two-wheeled vehicle, a pedestrian, a building, and so on.

When the self-driving vehicle 1220 to be controlled/interact within an XR image acquires sensor information from the sensors each including a camera, the self-driving vehicle 1220 or the XR device 1230 may generate the XR image based on the sensor information, and the XR device 1230 may output the generated XR image. The self-driving vehicle 1220 may operate based on a control signal received through an external device such as the XR device 1230 or based on the user's interaction.

VR, AR, and MR technologies of the present disclosure are applicable to various devices, particularly, for example, a HMD, a HUD attached to a vehicle, a portable phone, a tablet PC, a laptop computer, a desktop computer, a TV, and a signage. The VR, AR, and MR technologies may also be applicable to a device equipped with a flexible or rollable display.

The above-described VR, AR, and MR technologies may be implemented based on CG and distinguished by the ratios of a CG image in an image viewed by the user.

That is, VR provides a real object or background only in a CG image, whereas AR overlays a virtual CG image on an image of a real object.

MR is similar to AR in that virtual objects are mixed and combined with a real world. However, a real object and a virtual object created as a CG image are distinctive from each other and the virtual object is used to complement the real object in AR, whereas a virtual object and a real object are handled equally in MR. More specifically, for example, a hologram service is an MR representation.

These days, VR, AR, and MR are collectively called XR without distinction among them. Therefore, embodiments of the present disclosure are applicable to all of VR, AR, MR, and XR.

For example, wired/wireless communication, input interfacing, output interfacing, and computing devices are available as hardware (HW)-related element techniques applied to VR, AR, MR, and XR. Further, tracking and matching, speech recognition, interaction and user interfacing, location-based service, search, and AI are available as software (SW)-related element techniques.

Particularly, the embodiments of the present disclosure are intended to address at least one of the issues of communication with another device, efficient memory use, data throughput decrease caused by inconvenient user experience/user interface (UX/UI), video, sound, motion sickness, or other issues.

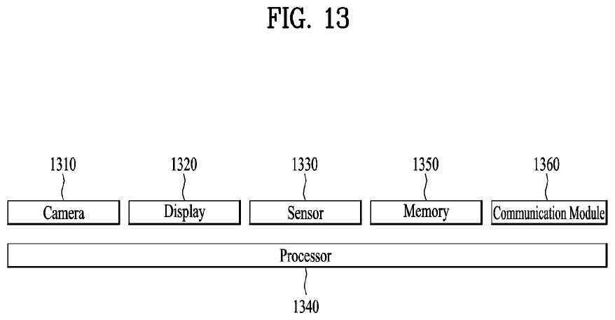

FIG. 13 is a block diagram illustrating an XR device according to embodiments of the present disclosure. The XR device 1300 includes a camera 1310, a display 1320, a sensor 1330, a processor 1340, a memory 1350, and a communication module 1360. Obviously, one or more of the modules may be deleted or modified, and one or more modules may be added to the modules, when needed, without departing from the scope and spirit of the present disclosure.

The communication module 1360 may communicate with an external device or a server, wiredly or wirelessly. The communication module 1360 may use, for example, Wi-Fi, Bluetooth, or the like, for short-range wireless communication, and for example, a 3GPP communication standard for long-range wireless communication. LTE is a technology beyond 3GPP TS 36.xxx Release 8. Specifically, LTE beyond 3GPP TS 36.xxx Release 10 is referred to as LTE-A, and LTE beyond 3GPP TS 36.xxx Release 13 is referred to as LTE-A pro. 3GPP 5G refers to a technology beyond TS 36.xxx Release 15 and a technology beyond TS 38.XXX Release 15. Specifically, the technology beyond TS 38.xxx Release 15 is referred to as 3GPP NR, and the technology beyond TS 36.xxx Release 15 is referred to as enhanced LTE. “xxx” represents the number of a technical specification. LTE/NR may be collectively referred to as a 3GPP system.

The camera 1310 may capture an ambient environment of the XR device 1300 and convert the captured image to an electric signal. The image, which has been captured and converted to an electric signal by the camera 1310, may be stored in the memory 1350 and then displayed on the display 1320 through the processor 1340. Further, the image may be displayed on the display 1320 by the processor 1340, without being stored in the memory 1350. Further, the camera 110 may have a field of view (FoV). The FoV is, for example, an area in which a real object around the camera 1310 may be detected. The camera 1310 may detect only a real object within the FoV. When a real object is located within the FoV of the camera 1310, the XR device 1300 may display an AR object corresponding to the real object. Further, the camera 1310 may detect an angle between the camera 1310 and the real object.

The sensor 1330 may include at least one sensor. For example, the sensor 1330 includes a sensing means such as a gravity sensor, a geomagnetic sensor, a motion sensor, a gyro sensor, an accelerator sensor, an inclination sensor, a brightness sensor, an altitude sensor, an olfactory sensor, a temperature sensor, a depth sensor, a pressure sensor, a bending sensor, an audio sensor, a video sensor, a global positioning system (GPS) sensor, and a touch sensor. Further, although the display 1320 may be of a fixed type, the display 1320 may be configured as a liquid crystal display (LCD), an organic light emitting diode (OLED) display, an electroluminescent display (ELD), or a micro LED (M-LED) display, to have flexibility. Herein, the sensor 1330 is designed to detect a bending degree of the display 1320 configured as the afore-described LCD, OLED display, ELD, or M-LED display.

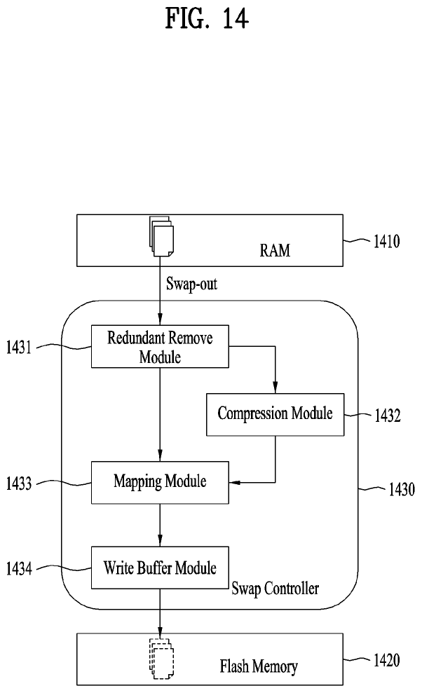

The memory 1350 is equipped with a function of storing all or a part of result values obtained by wired/wireless communication with an external device or a service as well as a function of storing an image captured by the camera 1310. Particularly, considering the trend toward increased communication data traffic (e.g., in a 5G communication environment), efficient memory management is required. In this regard, a description will be given below with reference to FIG. 14.

FIG. 14 is a detailed block diagram of the memory 1350 illustrated in FIG. 13. With reference to FIG. 14, a swap-out process between a random access memory (RAM) and a flash memory according to an embodiment of the present disclosure will be described.

When swapping out AR/VR page data from a RAM 1410 to a flash memory 1420, a controller 1430 may swap out only one of two or more AR/VR page data of the same contents among AR/VR page data to be swapped out to the flash memory 1420.

That is, the controller 1430 may calculate an identifier (e.g., a hash function) that identifies each of the contents of the AR/VR page data to be swapped out, and determine that two or more AR/VR page data having the same identifier among the calculated identifiers contain the same contents. Accordingly, the problem that the lifetime of an AR/VR device including the flash memory 1420 as well as the lifetime of the flash memory 1420 is reduced because unnecessary AR/VR page data is stored in the flash memory 1420 may be overcome.

The operations of the controller 1430 may be implemented in software or hardware without departing from the scope of the present disclosure. More specifically, the memory illustrated in FIG. 14 is included in a HMD, a vehicle, a portable phone, a tablet PC, a laptop computer, a desktop computer, a TV, a signage, or the like, and executes a swap function.

A device according to embodiments of the present disclosure may process 3D point cloud data to provide various services such as VR, AR, MR, XR, and self-driving to a user.

A sensor collecting 3D point cloud data may be any of, for example, a LiDAR, a red, green, blue depth (RGB-D), and a 3D laser scanner. The sensor may be mounted inside or outside of a HMD, a vehicle, a portable phone, a tablet PC, a laptop computer, a desktop computer, a TV, a signage, or the like.

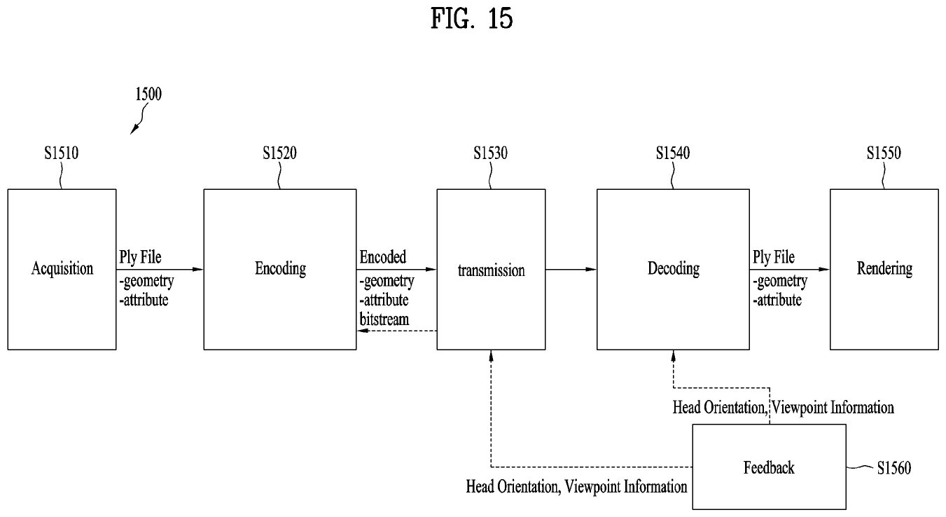

FIG. 15 illustrates a point cloud data processing system.

Referring to FIG. 15, a point cloud processing system 1500 includes a transmission device which acquires, encodes, and transmits point cloud data, and a reception device which acquires point cloud data by receiving and decoding video data. As illustrated in FIG. 15, point cloud data according to embodiments of the present disclosure may be acquired by capturing, synthesizing, or generating the point cloud data (S1510). During the acquisition, data (e.g., a polygon file format or standard triangle format (PLY) file) of 3D positions (x, y, z)/attributes (color, reflectance, transparency, and so on) of points may be generated. For a video of multiple frames, one or more files may be acquired. Point cloud data-related metadata (e.g., metadata related to capturing) may be generated during the capturing. The transmission device or encoder according to embodiments of the present disclosure may encode the point cloud data by video-based point cloud compression (V-PCC) or geometry-based point cloud compression (G-PCC), and output one or more video streams (S1520). V-PCC is a scheme of compressing point cloud data based on a 2D video codec such as high efficiency video coding (HEVC) or versatile video coding (VVC), G-PCC is a scheme of encoding point cloud data separately into two streams: geometry and attribute. The geometry stream may be generated by reconstructing and encoding position information about points, and the attribute stream may be generated by reconstructing and encoding attribute information (e.g., color) related to each point. In V-PCC, despite compatibility with a 2D video, much data is required to recover V-PCC-processed data (e.g., geometry video, attribute video, occupancy map video, and auxiliary information), compared to G-PCC, thereby causing a long latency in providing a service. One or more output bit streams may be encapsulated along with related metadata in the form of a file (e.g., a file format such as ISOBMFF) and transmitted over a network or through a digital storage medium (S1530).

The device or processor according to embodiments of the present disclosure may acquire one or more bit streams and related metadata by decapsulating the received video data, and recover 3D point cloud data by decoding the acquired bit streams in V-PCC or G-PCC (S1540). A renderer may render the decoded point cloud data and provide content suitable for VR/AR/MR/service to the user on a display (S1550).

As illustrated in FIG. 15, the device or processor according to embodiments of the present disclosure may perform a feedback process of transmitting various pieces of feedback information acquired during the rendering/display to the transmission device or to the decoding process (S1560). The feedback information according to embodiments of the present disclosure may include head orientation information, viewport information indicating an area that the user is viewing, and so on. Because the user interacts with a service (or content) provider through the feedback process, the device according to embodiments of the present disclosure may provide a higher data processing speed by using the afore-described V-PCC or G-PCC scheme or may enable clear video construction as well as provide various services in consideration of high user convenience.

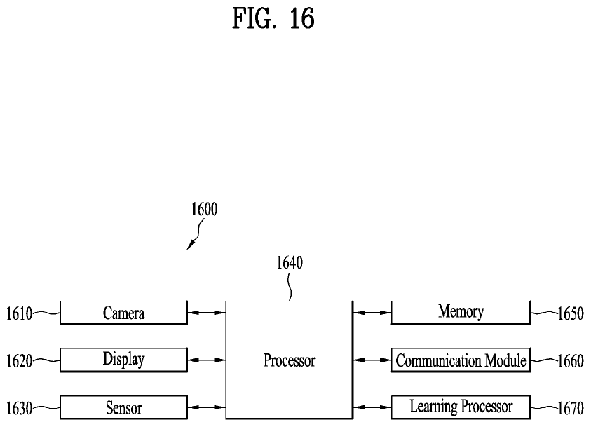

FIG. 16 is a block diagram of an XR device 1600 including a learning processor. Compared to FIG. 13, only a learning processor 1670 is added, and thus a redundant description is avoided because FIG. 13 may be referred to for the other components.

Referring to FIG. 16, the XR device 1600 may be loaded with a learning model. The learning model may be implemented in hardware, software, or a combination of hardware and software. If the whole or part of the learning model is implemented in software, one or more instructions that form the learning model may be stored in a memory 1650.

According to embodiments of the present disclosure, a learning processor 1670 may be coupled communicably to a processor 1640, and repeatedly train a model including ANNs by using training data. An ANN is an information processing system in which multiple neurons are linked in layers, modeling an operation principle of biological neurons and links between neurons. An ANN is a statistical learning algorithm inspired by a neural network (particularly the brain in the central nervous system of an animal) in machine learning and cognitive science. Machine learning is one field of AI, in which the ability of learning without an explicit program is granted to a computer. Machine learning is a technology of studying and constructing a system for learning, predicting, and improving its capability based on empirical data, and an algorithm for the system. Therefore, according to embodiments of the present disclosure, the learning processor 1670 may infer a result value from new input data by determining optimized model parameters of an ANN. Therefore, the learning processor 1670 may analyze a device use pattern of a user based on device use history information about the user. Further, the learning processor 1670 may be configured to receive, classify, store, and output information to be used for data mining, data analysis, intelligent decision, and a machine learning algorithm and technique.

According to embodiments of the present disclosure, the processor 1640 may determine or predict at least one executable operation of the device based on data analyzed or generated by the learning processor 1670. Further, the processor 1640 may request, search, receive, or use data of the learning processor 1670, and control the XR device 1600 to perform a predicted operation or an operation determined to be desirable among the at least one executable operation. According to embodiments of the present disclosure, the processor 1640 may execute various functions of realizing intelligent emulation (i.e., knowledge-based system, reasoning system, and knowledge acquisition system). The various functions may be applied to an adaptation system, a machine learning system, and various types of systems including an ANN (e.g., a fuzzy logic system). That is, the processor 1640 may predict a user's device use pattern based on data of a use pattern analyzed by the learning processor 1670, and control the XR device 1600 to provide a more suitable XR service to the UE. Herein, the XR service includes at least one of the AR service, the VR service, or the MR service.

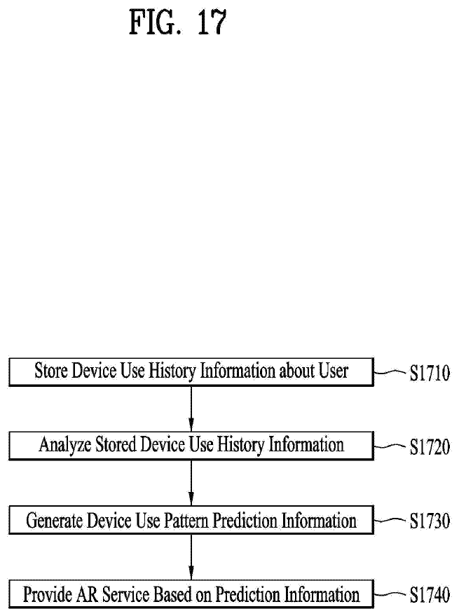

FIG. 17 illustrates a process of providing an XR service by the XR service 1600 of the present disclosure illustrated in FIG. 16.

According to embodiments of the present disclosure, the processor 1670 may store device use history information about a user in the memory 1650 (S1710). The device use history information may include information about the name, category, and contents of content provided to the user, information about a time at which a device has been used, information about a place in which the device has been used, time information, and information about use of an application installed in the device.

According to embodiments of the present disclosure, the learning processor 1670 may acquire device use pattern information about the user by analyzing the device use history information (S1720). For example, when the XR device 1600 provides specific content A to the user, the learning processor 1670 may learn information about a pattern of the device used by the user using the corresponding terminal by combining specific information about content A (e.g., information about the ages of users that generally use content A, information about the contents of content A, and content information similar to content A), and information about the time points, places, and number of times in which the user using the corresponding terminal has consumed content A.

According to embodiments of the present disclosure, the processor 1640 may acquire the user device pattern information generated based on the information learned by the learning processor 1670, and generate device use pattern prediction information (S1730). Further, when the user is not using the device 1600, if the processor 1640 determines that the user is located in a place where the user has frequently used the device 1600, or it is almost time for the user to usually use the device 1600, the processor 1640 may indicate the device 1600 to operate. In this case, the device according to embodiments of the present disclosure may provide AR content based on the user pattern prediction information (S1740).

When the user is using the device 1600, the processor 1640 may check information about content currently provided to the user, and generate device use pattern prediction information about the user in relation to the content (e.g., when the user requests other related content or additional data related to the current content). Further, the processor 1640 may provide AR content based on the device use pattern prediction information by indicating the device 1600 to operate (S1740). The AR content according to embodiments of the present disclosure may include an advertisement, navigation information, danger information, and so on.

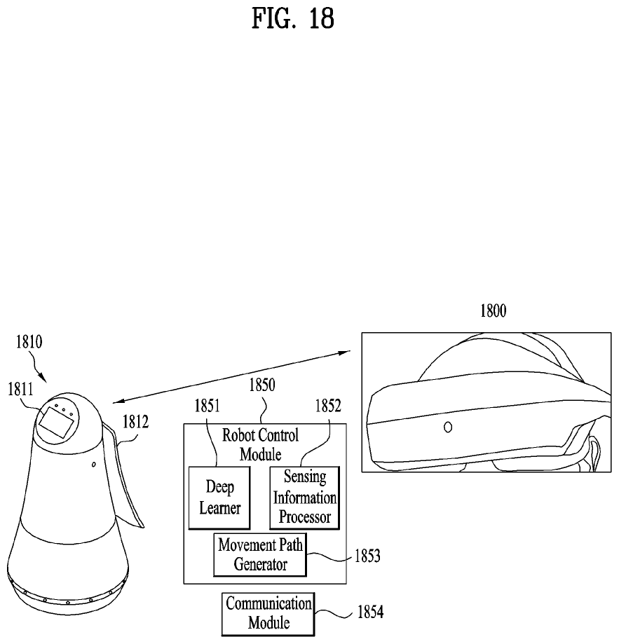

FIG. 18 illustrates the outer appearances of an XR device and a robot.

Component modules of an XR device 1800 according to an embodiment of the present disclosure have been described before with reference to the previous drawings, and thus a redundant description is not provided herein.

The outer appearance of a robot 1810 illustrated in FIG. 18 is merely an example, and the robot 1810 may be implemented to have various outer appearances according to the present disclosure. For example, the robot 1810 illustrated in FIG. 18 may be a drone, a cleaner, a cook root, a wearable robot, or the like. Particularly, each component of the robot 1810 may be disposed at a different position such as up, down, left, right, back, or forth according to the shape of the robot 1810.

The robot 1810 may be provided, on the exterior thereof, with various sensors to identify ambient objects. Further, to provide specific information to a user, the robot 1810 may be provided with an interface unit 1811 on top or the rear surface 1812 thereof.

To sense movement of the robot 1810 and an ambient object, and control the robot 1810, a robot control module 1850 is mounted inside the robot 1810. The robot control module 1850 may be implemented as a software module or a hardware chip with the software module implemented therein. The robot control module 1850 may include a deep learner 1851, a sensing information processor 1852, a movement path generator 1853, and a communication module 1854.

The sensing information processor 1852 collects and processes information sensed by various types of sensors (e.g., a LiDAR sensor, an IR sensor, an ultrasonic sensor, a depth sensor, an image sensor, and a microphone) arranged in the robot 1810.

The deep learner 1851 may receive information processed by the sensing information processor 1851 or accumulative information stored during movement of the robot 1810, and output a result required for the robot 1810 to determine an ambient situation, process information, or generate a moving path.

The moving path generator 1852 may calculate a moving path of the robot 1810 by using the data calculated by the deep learner 8151 or the data processed by the sensing information processor 1852.

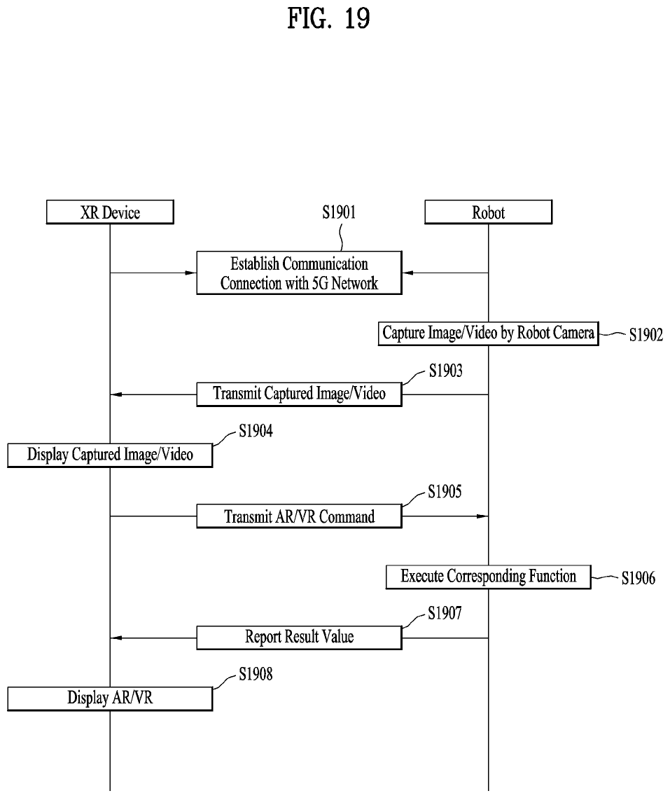

Because each of the XR device 1800 and the robot 1810 is provided with a communication module, the XR device 1800 and the robot 1810 may transmit and receive data by short-range wireless communication such as Wi-Fi or Bluetooth, or 5G long-range wireless communication. A technique of controlling the robot 1810 by using the XR device 1800 will be described below with reference to FIG. 19.

FIG. 19 is a flowchart illustrating a process of controlling a robot by using an XR device.

The XR device and the robot are connected communicably to a 5G network (S1901). Obviously, the XR device and the robot may transmit and receive data by any other short-range or long-range communication technology without departing from the scope of the present disclosure.

The robot captures an image/video of the surroundings of the robot by means of at least one camera installed on the interior or exterior of the robot (S1902) and transmits the captured image/video to the XR device (S1903). The XR device displays the captured image/video (S1904) and transmits a command for controlling the robot to the robot (S1905). The command may be input manually by a user of the XR device or automatically generated by AI without departing from the scope of the disclosure.

The robot executes a function corresponding to the command received in step S1905 (S1906) and transmits a result value to the XR device (S1907). The result value may be a general indicator indicating whether data has been successfully processed or not, a current captured image, or specific data in which the XR device is considered. The specific data is designed to change, for example, according to the state of the XR device. If a display of the XR device is in an off state, a command for turning on the display of the XR device is included in the result value in step S1907. Therefore, when an emergency situation occurs around the robot, even though the display of the remote XR device is turned off, a notification message may be transmitted.

AR/VR content is displayed according to the result value received in step S1907 (S1908).

According to another embodiment of the present disclosure, the XR device may display position information about the robot by using a GPS module attached to the robot.

The XR device 1300 described with reference to FIG. 13 may be connected to a vehicle that provides a self-driving service in a manner that allows wired/wireless communication, or may be mounted on the vehicle that provides the self-driving service. Accordingly, various services including AR/VR may be provided even in the vehicle that provides the self-driving service.

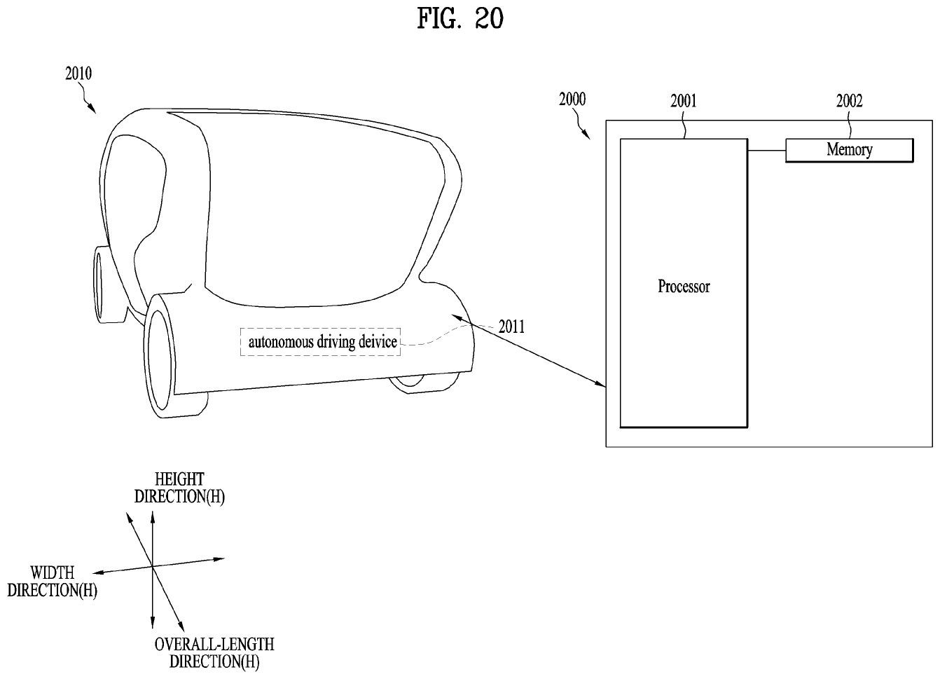

FIG. 20 illustrates a vehicle that provides a self-driving service.

According to embodiments of the present disclosure, a vehicle 2010 may include a car, a train, and a motor bike as transportation means traveling on a road or a railway. According to embodiments of the present disclosure, the vehicle 2010 may include all of an internal combustion engine vehicle provided with an engine as a power source, a hybrid vehicle provided with an engine and an electric motor as a power source, and an electric vehicle provided with an electric motor as a power source.

According to embodiments of the present disclosure, the vehicle 2010 may include the following components in order to control operations of the vehicle 2010: a user interface device, an object detection device, a communication device, a driving maneuver device, a main electronic control unit (ECU), a drive control device, a self-driving device, a sensing unit, and a position data generation device.

Each of the user interface device, the object detection device, the communication device, the driving maneuver device, the main ECU, the drive control device, the self-driving device, the sensing unit, and the position data generation device may generate an electric signal, and be implemented as an electronic device that exchanges electric signals.

The user interface device may receive a user input and provide information generated from the vehicle 2010 to a user in the form of a UI or UX. The user interface device may include an input/output (I/O) device and a user monitoring device. The object detection device may detect the presence or absence of an object outside of the vehicle 2010, and generate information about the object. The object detection device may include at least one of, for example, a camera, a LiDAR, an IR sensor, or an ultrasonic sensor. The camera may generate information about an object outside of the vehicle 2010. The camera may include one or more lenses, one or more image sensors, and one or more processors for generating object information. The camera may acquire information about the position, distance, or relative speed of an object by various image processing algorithms. Further, the camera may be mounted at a position where the camera may secure an FoV in the vehicle 2010, to capture an image of the surroundings of the vehicle 1020, and may be used to provide an AR/VR-based service. The LiDAR may generate information about an object outside of the vehicle 2010. The LiDAR may include a light transmitter, a light receiver, and at least one processor which is electrically coupled to the light transmitter and the light receiver, processes a received signal, and generates data about an object based on the processed signal.

The communication device may exchange signals with a device (e.g., infrastructure such as a server or a broadcasting station), another vehicle, or a terminal) outside of the vehicle 2010. The driving maneuver device is a device that receives a user input for driving. In manual mode, the vehicle 2010 may travel based on a signal provided by the driving maneuver device. The driving maneuver device may include a steering input device (e.g., a steering wheel), an acceleration input device (e.g., an accelerator pedal), and a brake input device (e.g., a brake pedal).

The sensing unit may sense a state of the vehicle 2010 and generate state information. The position data generation device may generate position data of the vehicle 2010. The position data generation device may include at least one of a GPS or a differential global positioning system (DGPS). The position data generation device may generate position data of the vehicle 2010 based on a signal generated from at least one of the GPS or the DGPS. The main ECU may provide overall control to at least one electronic device provided in the vehicle 2010, and the drive control device may electrically control a vehicle drive device in the vehicle 2010.

The self-driving device may generate a path for the self-driving service based on data acquired from the object detection device, the sensing unit, the position data generation device, and so on. The self-driving device may generate a driving plan for driving along the generated path, and generate a signal for controlling movement of the vehicle according to the driving plan. The signal generated from the self-driving device is transmitted to the drive control device, and thus the drive control device may control the vehicle drive device in the vehicle 2010.

As illustrated in FIG. 20, the vehicle 2010 that provides the self-driving service is connected to an XR device 2000 in a manner that allows wired/wireless communication. The XR device 2000 may include a processor 2001 and a memory 2002. While not shown, the XR device 2000 of FIG. 20 may further include the components of the XR device 1300 described before with reference to FIG. 13.

If the XR device 2000 is connected to the vehicle 2010 in a manner that allows wired/wireless communication. The XR device 2000 may receive/process AR/VR service-related content data that may be provided along with the self-driving service, and transmit the received/processed AR/VR service-related content data to the vehicle 2010. Further, when the XR device 2000 is mounted on the vehicle 2010, the XR device 2000 may receive/process AR/VR service-related content data according to a user input signal received through the user interface device and provide the received/processed AR/VR service-related content data to the user. In this case, the processor 2001 may receive/process the AR/VR service-related content data based on data acquired from the object detection device, the sensing unit, the position data generation device, the self-driving device, and so on. According to embodiments of the present disclosure, the AR/VR service-related content data may include entertainment content, weather information, and so on which are not related to the self-driving service as well as information related to the self-driving service such as driving information, path information for the self-driving service, driving maneuver information, vehicle state information, and object information.

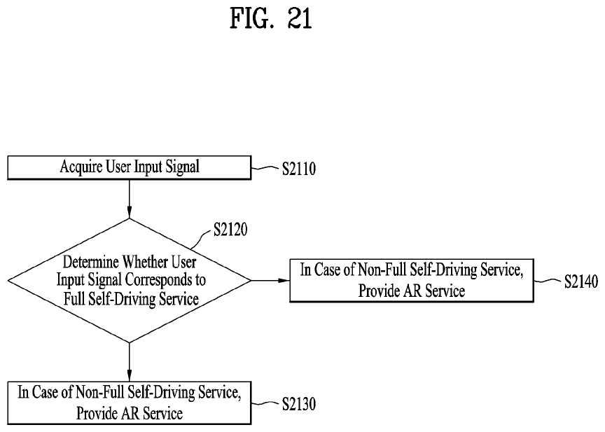

FIG. 21 illustrates a process of providing an AR/VR service during a self-driving service.

According to embodiments of the present disclosure, a vehicle or a user interface device may receive a user input signal (S2110). According to embodiments of the present disclosure, the user input signal may include a signal indicating a self-driving service. According to embodiments of the present disclosure, the self-driving service may include a full self-driving service and a general self-driving service. The full self-driving service refers to perfect self-driving of a vehicle to a destination without a user's manual driving, whereas the general self-driving service refers to driving a vehicle to a destination through a user's manual driving and self-driving in combination.

It may be determined whether the user input signal according to embodiments of the present disclosure corresponds to the full self-driving service (S2120). When it is determined that the user input signal corresponds to the full self-driving service, the vehicle according to embodiments of the present disclosure may provide the full self-driving service (S2130). Because the full self-driving service does not need the user's manipulation, the vehicle according to embodiments of the present disclosure may provide VR service-related content to the user through a window of the vehicle, a side mirror of the vehicle, an HMD, or a smartphone (S2130). The VR service-related content according to embodiments of the present disclosure may be content related to full self-driving (e.g., navigation information, driving information, and external object information), and may also be content which is not related to full self-driving according to user selection (e.g., weather information, a distance image, a nature image, and a voice call image).

If it is determined that the user input signal does not correspond to the full self-driving service, the vehicle according to embodiments of the present disclosure may provide the general self-driving service (S2140). Because the FoV of the user should be secured for the user's manual driving in the general self-driving service, the vehicle according to embodiments of the present disclosure may provide AR service-related content to the user through a window of the vehicle, a side mirror of the vehicle, an HMD, or a smartphone (S2140).

The AR service-related content according to embodiments of the present disclosure may be content related to full self-driving (e.g., navigation information, driving information, and external object information), and may also be content which is not related to self-driving according to user selection (e.g., weather information, a distance image, a nature image, and a voice call image).

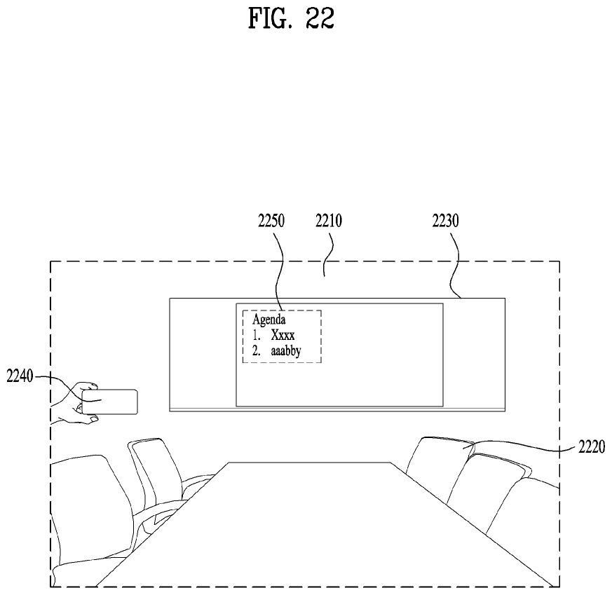

While the present disclosure is applicable to all the fields of 5G communication, robot, self-driving, and AI as described before, the following description will be given mainly of the present disclosure applicable to an XR device with reference to FIGS. 22 to 40. However, implementation of another embodiment by combining FIGS. 22 to 40 referring to FIGS. 1 to 21 by those skilled in the art also falls within the scope of the present disclosure.

Particularly, the XR device which will be described with reference to FIGS. 22 to 40 is applicable to a multimedia service equipped with both of the AR function and the VR function. Further, the XR device may correspond to a UE described before with reference to FIGS. 1 to 9, and thus perform 5G communication additionally.

FIG. 22 is a diagram referred to for describing a trigger condition for switching from AR mode to VR mode according to an embodiment of the present disclosure.

An XR device according to an embodiment of the present disclosure may provide both of the AR mode and the VR mode.

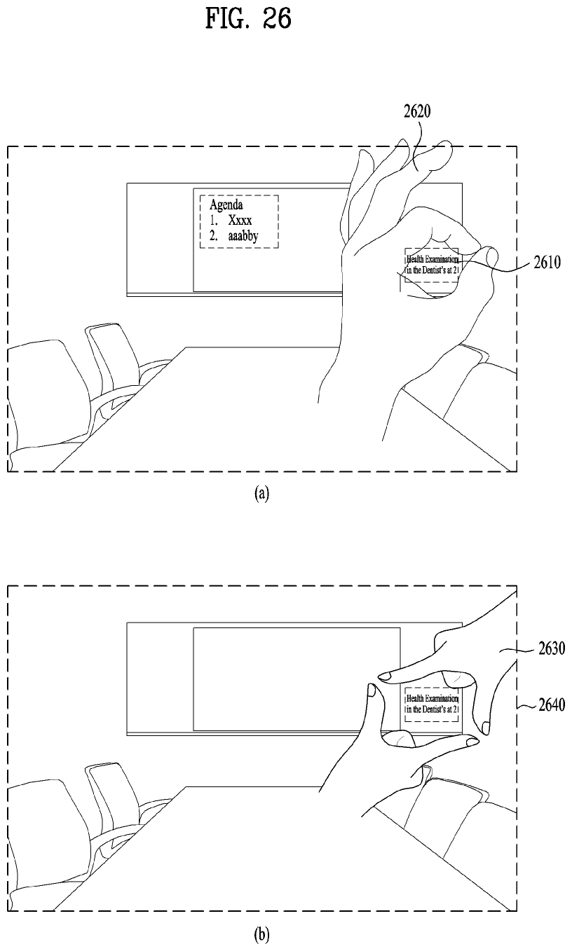

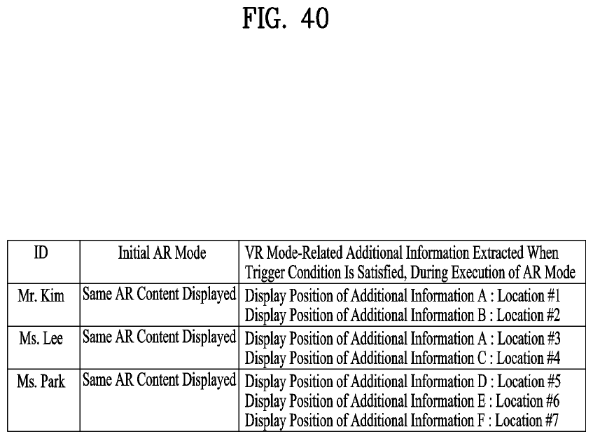

Referring to FIG. 22, when the XR device executes the AR mode, an AR-mode screen 2210 is displayed. If a predetermined trigger condition is satisfied during execution of the AR mode, the XR device accesses a memory and extracts additional information related to the VR mode from the memory. The trigger condition will be described later in detail with reference to FIGS. 26 to 32, and the memory and the VR mode-related additional information will be described in detail with reference to FIG. 40.

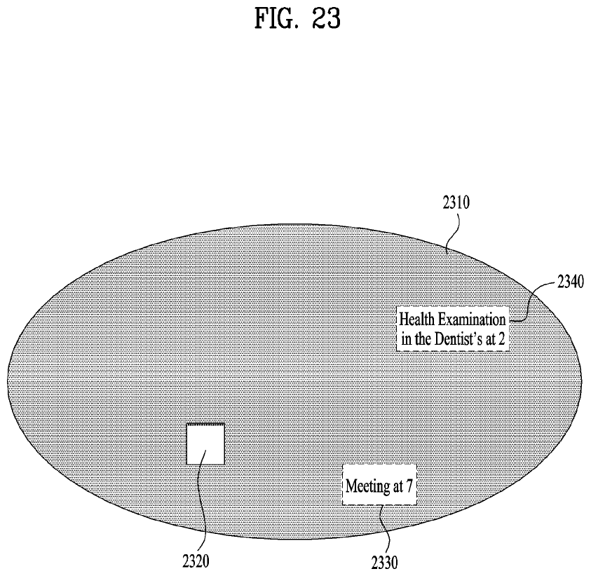

The XR device displays a virtual object 2250, which is located at a specific position on a VR-mode screen, on the AR-mode screen 2210, based on the VR mode-related additional information extracted from the memory. The VR-mode screen will be described later in detail with reference to FIG. 23.

With reference made again to FIG. 22, the XR device according to an embodiment of the present disclosure is displaying the AR-mode screen 2210. That is, the AR-mode screen 2210 displays, for example, objects 2220, 2230, and 2240 in the real world. The objects 2220, 2230, and 2240 correspond to objects captured by, for example, a camera of the XR device.

On the contrary, if the predetermined trigger condition is not satisfied, the object 2250 of the VR-mode screen is not initially displayed. The object 2250 corresponds to at least one virtual object mapped on a position basis on the VR-mode screen.

Even though the AR mode is being executed, if the predetermined trigger condition is satisfied (e.g., when a portable phone 2240 is recognized at the position of a virtual object on a personalized VR-mode screen), the virtual object 2250 of the VR-mode screen is automatically displayed even on the AR-mode screen 2210. Accordingly, the technical effect of remarkably reducing a processing time for AR-VR mode switching is achieved.

While the position of the mobile device 2240 as a reference device for the predetermined trigger condition is tracked in FIG. 22 by way of example, it may be designed that a user's gaze is tracked through the camera of the XR device.

A virtual object displayed on a VR-mode screen as mentioned in the present disclosure is technically distinguished from general AR content in the AR mode. There is no dependency between a user and AR content displayed along with a real object in the AR mode. That is, AR content just means information related to a real object recognized in the AR mode, which is displayed at a predetermined position. On the other hand, a virtual object on a VR-mode screen as defined in the present disclosure is different content displayed at a different position for each user recognized by the XR device. For the convenience of description, for example, the virtual object of the VR-mode screen may correspond to a background screen for the AR/VR service, predetermined on a user basis.

Therefore, compared to the conventional technology in which only AR content related to a real object is displayed in the AR mode, virtual objects of a personalized VR-mode screen are fast loaded even in the AR mode, and thus displayed along with a real object and AR content on the AR screen in an embodiment of the present disclosure.

A personalized VR-mode screen which is allowed to be displayed on an AR-mode screen will be described below with reference to FIG. 23.

FIG. 23 illustrates a personalized VR-mode screen provided by an XR device according to an embodiment of the present disclosure.

As illustrated in FIG. 23, multiple virtual objects are located at specific positions on a personalized VR-mode screen. For example, user A disposes a calendar-related virtual object 2320 at a first position, a memo-related virtual object 2330 indicating “meeting at 7” at a second position, and a memo-related virtual object 2340 indicating “health examination at the dentist's at 2” at a third position, on a VR-mode screen 2310.

While FIG. 23 is shown from the perspective of user A, user B may designate a different virtual object at a different position on the VR-mode screen 2310.

While the background screen of the VR-mode screen 2310 is shown as a predetermined black screen in FIG. 23, a graphical representation of a real object recognized in the AR mode of FIG. 22 as the background screen also falls within the scope of another embodiment of the present disclosure.

For example, a working environment recognized in the AR mode may be graphically represented as the background screen of the personalized VR-mode screen.

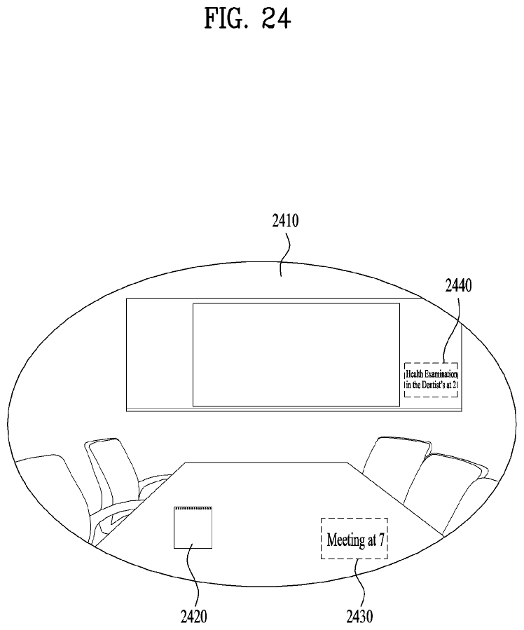

The process of loading the virtual objects 2320, 2330, and 2340 of the VR-mode screen 2310 illustrated in FIG. 23 from the memory and displaying the loaded virtual objects 2320, 2330, and 2340 on the AR-mode screen will be described below in detail with reference to FIG. 24.

FIG. 24 is a diagram referred to for describing a process of displaying, on an AR-mode screen, a virtual object which is located at a predetermined position on a VR-mode screen, during display of the AR-mode screen.

FIG. 24 pertains to an AR-mode screen 2410 provided by the XR device according to an embodiment of the present disclosure. Accordingly, only a real object captured by the camera of the XR device and AR content are initially displayed (before the predetermined trigger condition is satisfied), as done conventionally.

However, if the predetermined trigger condition is satisfied, the virtual objects of the VR-mode screen illustrated in FIG. 23 are loaded, and virtual objects 2420, 2430, and 2440 are displayed on the AR-mode screen 2410, as illustrated in FIG. 24.

Particularly, because the positions of the virtual objects 2420, 2430, and 2440 displayed on the AR-mode screen 2410 are identical to user-predetermined positions on the personalized VR-mode screen, the user may conveniently control the virtual objects 2420, 2430, and 2440.

While it is assumed in FIG. 24 that the positions of the virtual objects 2420, 2430, and 2440 displayed on the AR-mode screen 2410 are identical to the user-predetermined positions on the personalized VR-mode screen (see FIG. 23), the positions of the virtual objects of the VR-mode screen may fully or partially overlap with the positions of AR content because the virtual objects of the VR-mode screen are displayed on the AR-mode screen.

In this case, the positions of the virtual objects of the VR-mode screen may be subjected to fine adjustment, or the AR content or the virtual objects may be displayed in a different domain/depth (3D processing) to avoid the overlap, which may fall within the scope of the present disclosure.

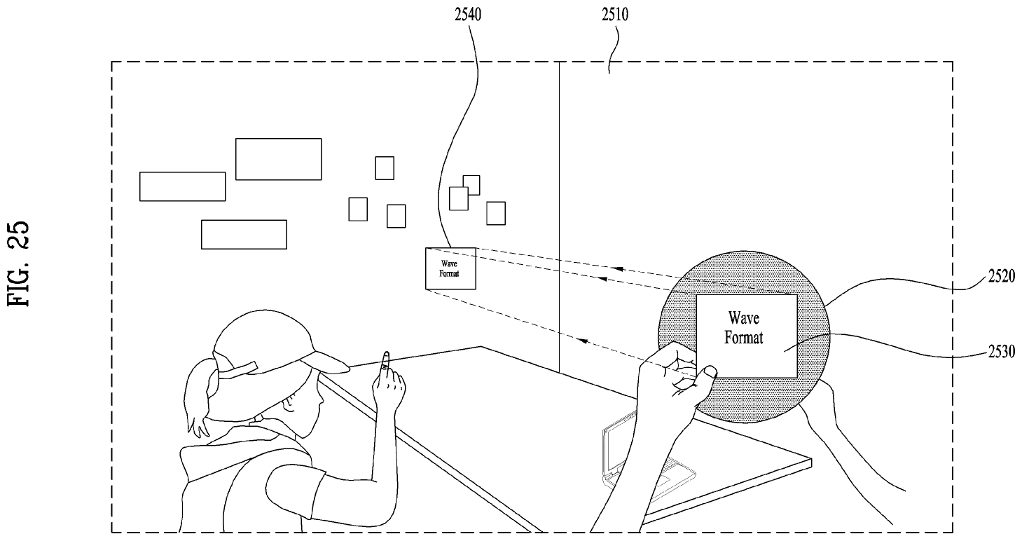

A process of moving a real object on an AR-mode screen to a VR-mode screen or moving a virtual object on a VR-mode screen to an AR-mode screen will be described below with reference to FIG. 25.

FIG. 25 is a diagram referred to for describing a process of moving a virtual object on a VR-mode screen to an AR-mode screen according to an embodiment of the present disclosure.

As illustrated in FIG. 25, the XR device according to an embodiment of the present disclosure provides an AR-mode screen 2510. Before the predetermined trigger condition is satisfied, only a real object and AR content are displayed without VR mode-related information, similarly to the conventional technology.

If the predetermined trigger condition is satisfied, an indicator 2520 allowing entry into a personalized VR-mode screen and a virtual object 2530 located on the personalized VR-mode screen are displayed together.

When a gesture is recognized, the virtual object 2530 of the personalized VR-mode screen moves to a position 2540 on an AR screen 2510. The object displayed at the position 2540 on the AR screen 2510 is different from AR content and the source of the object is the personalized VR-mode screen, compared to the conventional technology.

The gesture will be described in greater detail.

In an embodiment, if a user's hand is recognized in the indicator 2520 allowing entry into the personalized VR-mode screen for a first predetermined time or longer by the camera of the XR device, and a successive hand gesture of moving the virtual object to a position on the AR-mode screen, and the hand is recognized at the position for a second predetermined time or longer by the camera of the XR device, the virtual object is displayed at the position. For example, the predetermined first time and the predetermined second time may be equal or different.

In another embodiment, if a user's gaze is recognized in the indicator 2520 allowing entry into the personalized VR-mode screen for a third predetermined time or longer by the camera of the XR device, and a successive user's gaze of moving the virtual object to a position on the AR-mode screen, and the user's gaze is recognized at the position for a fourth predetermined time or longer by the camera of the XR device, the virtual object is displayed at the position. For example, the predetermined third time and the predetermined fourth time may be equal or different.

The afore-described predetermined trigger condition will be described in detail with reference to FIGS. 26, 27 and 28.

The predetermined trigger condition includes recognition of a tracked user's gaze or specific device in a specific area of an AR-mode screen for a predetermined time.

Obviously, defining a trigger condition independently of tracking also falls within the scope of the present disclosure. For example, the trigger condition may be a first condition that a specific physical key button on the XR device or a corresponding remote control is pushed, a second condition that a specific motion of the XR device or the corresponding remote control is sensed, or a third condition that a specific gesture is sensed by the camera of the XR device.

More specifically, for example, if the trigger condition corresponds to the third condition, a virtual object displayed on the AR-mode screen may be changed according to the size or position of an area in which the specific gesture is made.

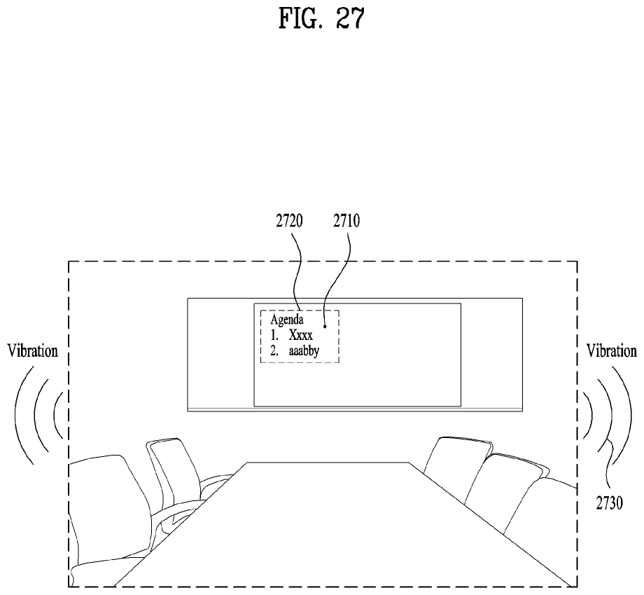

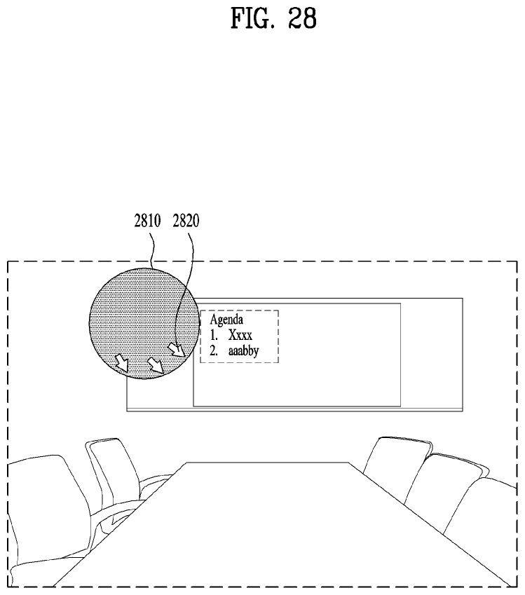

The predetermined trigger condition may be satisfied by a specific gesture as illustrated in FIG. 26, or by a user's gaze as illustrated in FIG. 27. In the illustrated cases of FIGS. 26 and 27, however, the user should pre-memorize the position of a virtual object on the personalized VR-mode screen. To overcome this limitation, the concept of an indicator is introduced in FIG. 28.

FIG. 26 is a diagram illustrating a process of changing the size of a displayed object of a VR-mode screen during display of an AR-mode screen according to an embodiment of the present disclosure.

As illustrated in FIG. 26(a), when a first specific gesture 2620 is recognized in an area corresponding to the position of a virtual object 2610 of the VR-mode screen during display of an AR-mode screen, the virtual object 2610 is displayed at a corresponding position on the AR-mode screen. Accordingly, to load a VR-mode virtual object in the AR mode, two conditions that the first specific gesture 2620 is to be recognized at the position of the virtual object should be satisfied.

Further, changing the size of the displayed virtual object 2610 in response to recognition of a gesture for adjusting the size of a circle formed initially by the first specific gesture 2620 also falls within the scope of the present disclosure.

As illustrated in FIG. 26(b), when a second specific gesture 2630 is recognized in an area corresponding to the position of a virtual object 2640 of a VR-mode screen during display of an AR-mode screen, the virtual object 2640 is displayed at a corresponding position on the AR-mode screen. Accordingly, to load a VR-mode virtual object in the AR mode, two conditions that the second specific gesture 2630 is to be recognized at the position of the virtual object should be satisfied.

Further, changing the size of the displayed virtual object 2640 in response to recognition of a gesture for adjusting the size of a square formed initially by the second specific gesture 2630 also falls within the scope of the present disclosure.

FIG. 27 is a diagram illustrating a feedback process in response to recognition of a virtual object at a specific position on a VR-mode screen during display of an AR-mode screen according to an embodiment of the present disclosure.

The XR device according to an embodiment of the present disclosure includes both of a first camera for capturing what is ahead of the device and a second camera for capturing a user's gaze.

Therefore, when the AR mode is executed, it is possible to display a guide graphic image 2710 corresponding to a user's gaze tracked and captured by the second camera along with real objects captured by the first camera.

When the guide graphic image 2710 is recognized in a specific area in which a virtual object 2720 is located on a VR-mode screen during execution of the AR mode, the virtual object 2720 is displayed.

To perform this process, the user should know the position of the virtual object on the VR-mode screen. To minimize a process of searching for a virtual object by the user, when the guide graphic image 2710 corresponding to the tracked user's gaze is recognized at the position of the virtual object, outputting feedback vibrations 2730 in response to the recognition also falls within the scope of the present disclosure.

Further, in another embodiment, to facilitate detection of a VR-mode virtual object during execution of the AR mode, it is possible to generate the vibration feedback 2730 even when the guide graphic image 2710 is spaced from the specific area in which the virtual object is located on the VR-mode screen by a distance equal to a predetermined ratio of the total size of the virtual object, without perfect match.

For example, if the size of the specific area in which the virtual object is located is 2 cm×4 cm, when the guide graphic image 2710 is apart from the area by 0.2 cm or 0.4 cm equal to 10% of the length or width, a vibration feedback may be generated, thereby inducing the user's gaze to the virtual object.

However, the operations illustrated in FIGS. 26 and 27 require that the position of a virtual object on a personalized VR-mode screen should be known accurately or within an error range. A solution to this problem will be described below with reference to FIG. 28.

FIG. 28 illustrates a first sub-embodiment of a GUI for guiding to the position of a virtual object on a VR-mode screen during display of an AR-mode screen according to an embodiment of the present disclosure.

Unlike FIGS. 26 and 27, the embodiment of FIG. 28 obviates the need for the user to memorize the position of an object on a virtual-mode screen by further displaying an indicator for guiding the user to at least one virtual object on the VR-mode screen during execution of the AR mode.

Referring to FIG. 28, the XR device executes the AR mode and displays an AR-mode screen. Upon occurrence of a specific event, a GUI 2810 for providing information about a virtual object on a personalized VR-mode screen is displayed.

As illustrated in FIG. 28, particularly, the GUI 2810 includes a sub-GUI 2820 that guides the user to a specific position at which a virtual object is located on a personalized VR-mode screen. Therefore, the user may load the object of the VR-mode screen and display the virtual object by moving a gaze or a portable phone, referring to the afore-described GUIs 2810 and 2820 even though the user does not memorize the position of the object on the personalized VR-mode screen.

For example, the moment the AR mode is executed, the specific event may be displayed, and the specific event may include recognition of a specific button or gesture (e.g., shaking the XR device sideways twice for a predetermined time).

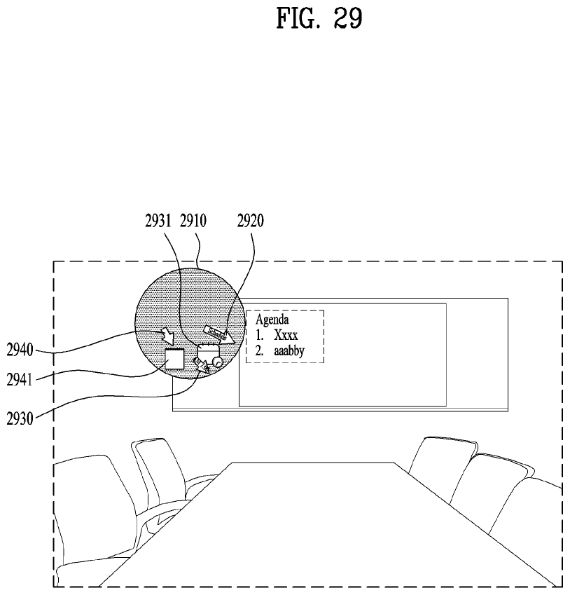

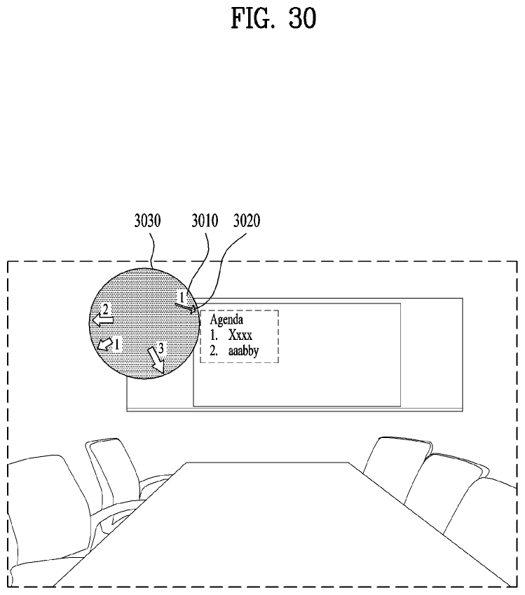

While the GUIs 2810 and 2820 are shown in a simple manner in FIG. 28, by way of example, other embodiments for increasing user convenience and a data processing speed by further specifying the GUIs 2810 and 2820 will be described with reference to FIGS. 29 and 30.

FIG. 29 is a diagram illustrating a second sub-embodiment of a GUI for guiding to the position of a virtual object on a VR-mode screen during display of an AR-mode screen according to an embodiment of the present disclosure.

FIG. 30 is a diagram illustrating a third sub-embodiment of a GUI for guiding to the position of a virtual object on a VR-mode screen during display of an AR-mode screen according to an embodiment of the present disclosure.

Information included in a GUI for guiding to the position of a virtual object on a VR-mode screen during display of an AR-mode screen includes, for example, first graphic data indicating the type of at least one virtual object on the VR-mode screen, second graphic data indicating the position of the at least one virtual object on the VR-mode screen, and third graphic data indicating the number of the at least one virtual object on the VR-mode screen.

FIG. 29 illustrates a case in which the first graphic data and the second graphic data are included in the GUI, and FIG. 30 illustrates a case in which the second graphic data and the third graphic data are included in the GUI.

Referring to FIG. 29, it is assumed that the XR device according to an embodiment of the present disclosure executes the AR mode and then is displaying an AR-mode screen.

When the afore-described specific event is sensed, an indicator 2910 related to a virtual object stored in a personalized VR mode-screen is displayed. The indicator 2910 may be referred to as a GUI.

The indicator 2910 in the form of a GUI restrictively displays only some user-desired virtual object (in the VR mode) without displaying the whole VR-mode screen during execution of the AR mode. Therefore, there is no need for switching to the VR mode, and a data processing speed may be increased significantly.

The indicator 2910 displayed in the AR mode functions to indicate the position and type of the virtual object stored in the personalized VR mode-screen. More specifically, for example, as illustrated in FIG. 29, the indicator 2910 indicates that there are a memo-type virtual object 2941 in a first direction 2940 and a calendar-type virtual object 2931 in a second direction 2941 in the personalized VR-mode screen, and indicates only a direction 2920 for a virtual object of a type which is not identified.

Therefore, a time taken for detecting the position of a VR-mode virtual object during execution of the AR mode may be reduced significantly.

Like FIG. 29, FIG. 30 is also based on the assumption that the XR device according to an embodiment of the present disclosure executes the AR mode and then is displaying an AR-mode screen.

When the afore-described predetermined event is sensed, an indicator 3030 related to a virtual object stored in a personalized VR-mode screen is displayed. The indicator 3030 may be referred to as a GUI.

The indicator 3030 in the form of a GUI restrictively displays only some user-desired virtual object (in the VR mode) without displaying the whole VR-mode screen during execution of the AR mode. Therefore, there is no need for switching to the VR mode, and a data processing speed may be increased significantly.

The indicator 3030 displayed in the AR mode functions to indicate the positions and number of virtual objects stored in the personalized VR mode-screen. More specifically, for example, as illustrated in FIG. 30, the indicator 3030 indicates the number 3010 of virtual objects in a specific direction 3020 on the personalized VR-mode screen.

Therefore, a time taken for detecting the position of a VR-mode virtual object during execution of the AR mode may be reduced significantly.

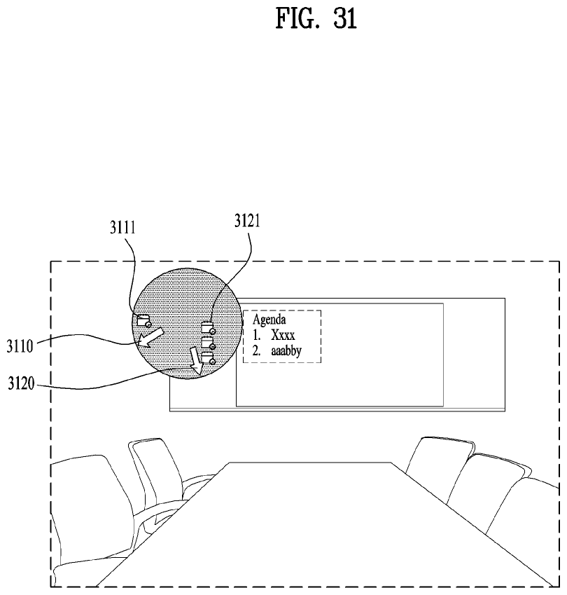

However, FIGS. 29 and 30 have limitations in displaying all of the directions, positions, and number of virtual objects. An embodiment of overcoming this problem will be described with reference to FIG. 31.

FIG. 31 is a diagram illustrating a fourth sub-embodiment of a GUI for guiding to the position of a virtual object on a VR-mode screen during display of an AR-mode screen according to an embodiment of the present disclosure.

Like FIGS. 29 and 30, FIG. 31 is also based on the assumption that the XR device according to an embodiment of the present disclosure executes the AR mode and then is displaying an AR-mode screen.

When the afore-described predetermined event is sensed, an indicator related to a virtual object stored in a personalized VR-mode screen is displayed.

The indicator displayed in the AR mode functions to indicate the type 3111 and direction 3110 of a first virtual object and the type 3121 and direction 3120 of a second virtual object stored in the personalized VR mode-screen. A comparison between the GUIs of the first and second virtual objects reveals that the numbers of CG images indicating the types 311 and 3121 of the first and second virtual objects are different, and thus a position with more information may easily be identified.

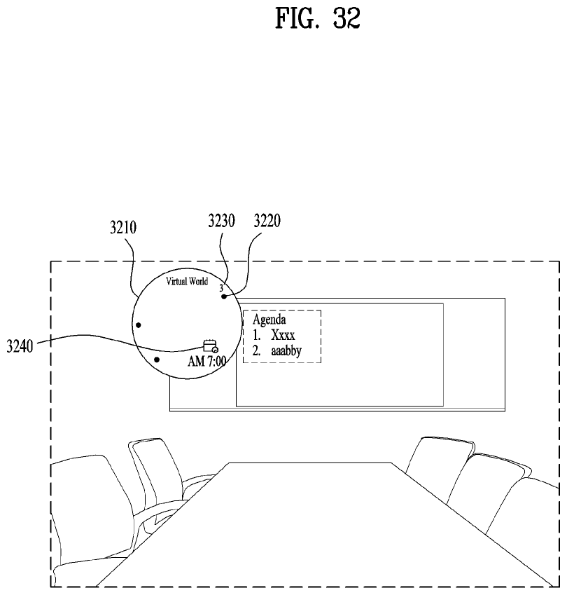

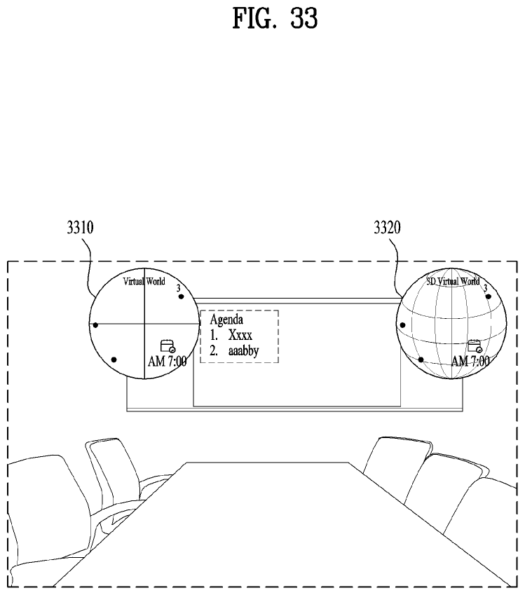

However, although the embodiment of FIG. 31 enables acquisition of information about the directionality of a virtual object in a personalized VR-mode screen, the embodiment of FIG. 31 does not provide information about a detailed position of the virtual object. A method of solving this problem will be described below with reference to FIGS. 32 and 33.

FIG. 32 is a diagram illustrating a fifth sub-embodiment of a GUI for guiding to the position of a virtual object on a VR-mode screen during display of an AR-mode screen according to an embodiment of the present disclosure.

FIG. 32 is also based on the assumption that the XR device according to an embodiment of the present disclosure executes the AR mode and then is displaying an AR-mode screen.

When the afore-described predetermined event is sensed, an indicator related to a virtual object stored in a personalized VR-mode screen is displayed.

An indicator 3210 displayed in the AR mode more specifically indicates the position 3220 of a virtual object stored in the personalized VR-mode screen. Since the indicator 3210 indicates both of the number 3230 and type 3240 of the virtual object based on the foregoing embodiments, the technical effects of the foregoing embodiments are all taken.

A VR service may also be implemented in a 3D space, not limited to a 2D space. However, the embodiment of FIG. 32 has limitations in providing accurate 3D position information. An embodiment of solving this problem will be described below with reference to FIG. 33.

FIG. 33 is a diagram illustrating 2D and 3D representations of a GUI for guiding to the position of a virtual object on a VR-mode screen during display of an AR-mode screen according to an embodiment of the present disclosure.

While a guide GUI 3310 on a 2D plane illustrated in FIG. 33 is similar to the GUI of FIG. 32, a 3D guide GUI 3320 illustrated in FIG. 33 is implemented on a 3D domain, unlike FIG. 32.

Accordingly, more virtual objects may be positioned and more VR virtual objects may be loaded during execution of an AR mode, by more efficient use of the space of the personalized VR-mode screen.

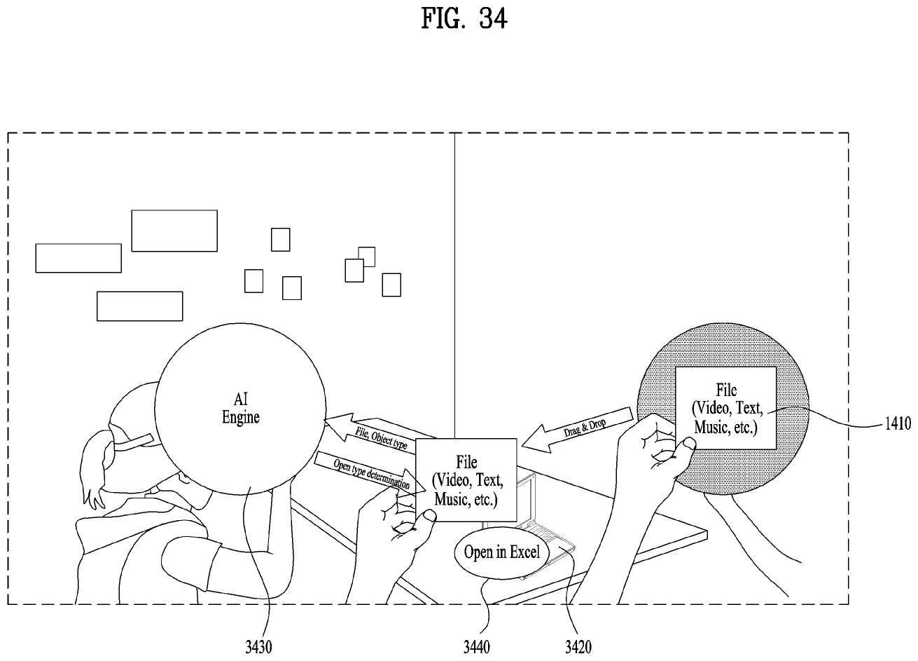

While the description of FIGS. 22 to 33 has focused on the AR/VR service, another embodiment in which an AI environment is applied to the AR/VR service will be described below with reference to FIG. 34.

FIG. 34 is a diagram illustrating a process of providing an AR/VR service in an AI environment by an XR device according to an embodiment of the present disclosure.

The XR device according to an embodiment of the present disclosure may be AI-enabled or receive additional information by communicating with an AI-enabled server.

For example, when a virtual object (or item) on a personalized VR-mode screen is moved to an AR screen, different control is performed according to the features of an object in the real world. When the virtual object is reproduced, it may be reproduced in AR or in a linked real object.

More specifically, for example, when a file on a personalized VR-mode screen is attached to a TV on an AR-mode screen, a video is played on a TV augmented with AR content or in a real TV. It is assumed that a communication connection has been established between the XR device of the present disclosure and the TV by pairing or the like.

In another example, when a file on the personalized VR-mode screen is attached to an audio player on the AR-mode screen, music is played on a player augmented with AR content or in a real audio player. It is assumed that a communication connection has been established between the XR device of the present disclosure and the audio player by pairing or the like.

In another example, when a file (e.g., a book or e-book) on the personalized VR-mode screen is attached to a tablet on the AR-mode screen, corresponding text is reproduced on a player augmented with AR content or in a real tablet. It is assumed that a communication connection has been established between the XR device of the present disclosure and the real tablet by pairing or the like.

In another example, when a file on the personalized VR-mode screen is attached to a laptop on the AR-mode screen, the file is opened on a player augmented with AR content or in a real laptop. It is assumed that a communication connection has been established between the XR device of the present disclosure and the real laptop by pairing or the like.

Therefore, machine learning is used in interpreting objects in the real world, searching for a linked optimum object, and opening a file in a suitable format by AI.

Referring to FIG. 34 again, when some VR-mode virtual object 1410 retrieved during execution of the AR mode is attached to a real object on the AR-mode screen, an AI engine 3430 analyzes the real object on the AR-mode screen and open a file in a corresponding real device, or search for a more suitable device to open the file.

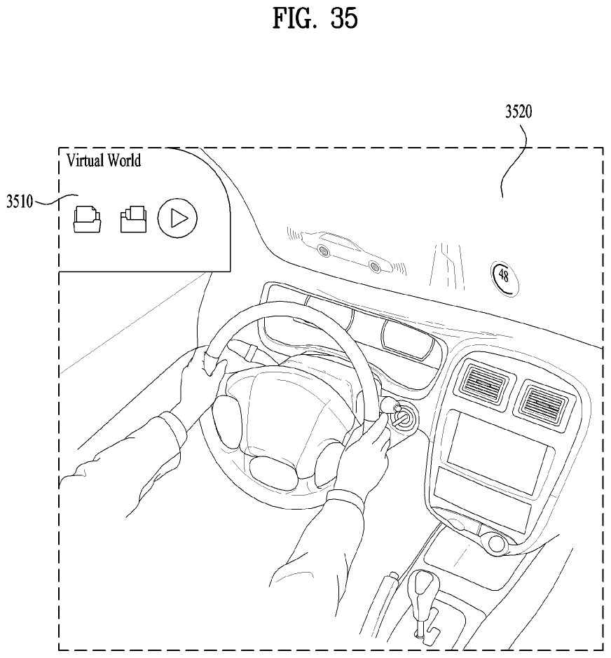

FIG. 35 is a diagram illustrating a process of providing an AR/VR service in a self-driving environment by an XR device according to an embodiment of the present disclosure.

While the AR/VR service has mainly been described with reference to FIGS. 22 to 33, another embodiment in which a self-driving environment is applied to the AR/VR device will be described with reference to FIG. 35.

The XR device according to an embodiment of the present disclosure is capable of communicating with a self-driving vehicle.

For example, when the self-driving vehicle is sensed as traveling at or above a predetermined speed or a predetermined condition (e.g., entry into full self-driving mode or semi-self-driving mode) is satisfied during driving, at least one of windows on a driver's side and a passenger's side is switched to the VR mode. If content in the VR mode is dragged and dropped on another window in the vehicle, the content is also displayed on the other window.

Referring to FIG. 35 again, if at least one of the above-described conditions is satisfied, virtual objects 3510 on a personalized VR-mode screen are displayed on a side window to the left of a driver in the vehicle.

If one of the virtual objects 3510 is dragged and dropped on a front window 3520, the virtual object is reproduced on the front window 3520.

Because the vehicle is a self-driving vehicle, even covering the whole front window does not affect safety.

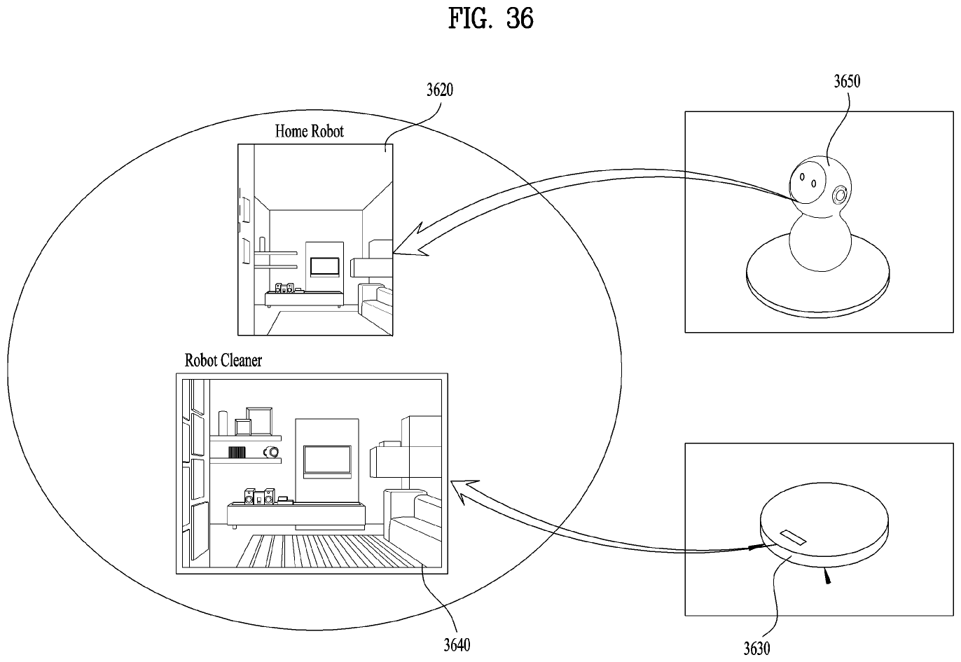

While the AR/VR service has mainly been described with reference to FIGS. 22 to 33, another embodiment in which a robot environment is applied to the AR/VR service will be described with reference to FIG. 36.

FIG. 36 is a diagram illustrating a first process of providing an AR/VR service in a robot environment by an XR device according to an embodiment of the present disclosure.

As robots have become popular owing to the development of robot technology, various types of robots (e.g., robot cleaners and home robots equipped with a closed-circuit TV (CCTV) function) are used at homes. Further, the development of 5G communication technology enables fast, accurate communication between in-house robots and a remote AR/VR device.

Therefore, it is possible to provide information collected from, for example, a robot cleaner or a home robot as an object or a widget in the AR/VR mode through 5G communication. Furthermore, the collected information may be displayed in a pop-up manner on a screen of the AR/VR mode according to a specific condition (e.g., movement or update of content). Accordingly, a time taken to provide unnecessary information may be reduced.

Referring to FIG. 36 again, an XR device capable of providing the AR mode and the VR mode first establishes a communication connection of 5G or the like with a home robot 3650 and a robot cleaner 3630.

Further, the XR device displays first additional information 3620 received from the home robot 3650 on an AR-mode or VR-mode screen by communicating with the home robot 3650. Further, the XR device displays second additional information 3640 received from the robot cleaner 3630 on the AR-mode or VR-mode screen by communicating with the robot cleaner 3630.

As described before, if a predetermined trigger condition is satisfied during reproduction of an AR-mode screen, selective display of the first additional information or the second additional information also falls within the scope of the present disclosure.

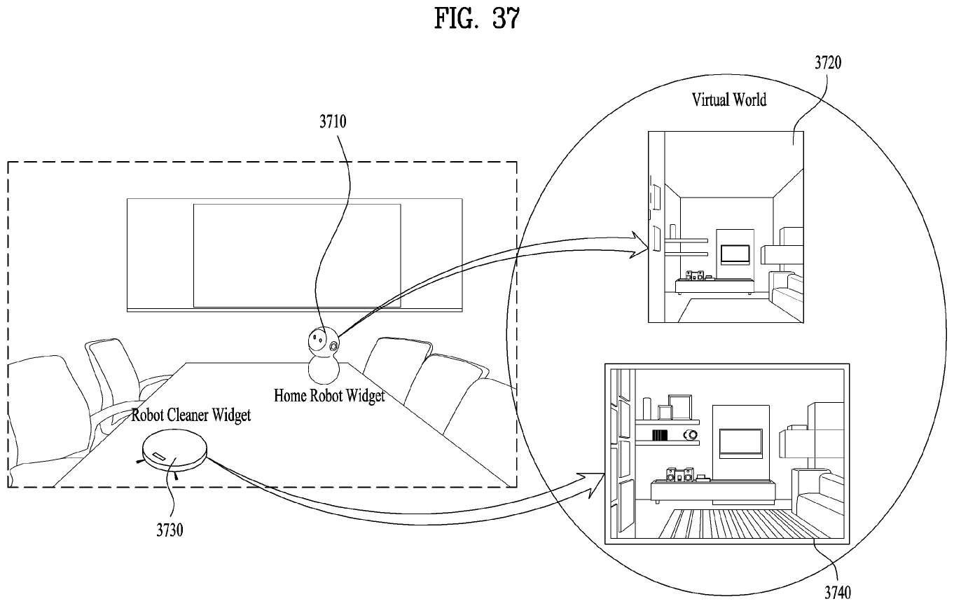

While it has been described with reference to FIG. 36 that an XR device in the AR/VR mode displays data of a robot in a passive manner, the XR device may control the robot more actively. In this regard, FIG. 37 will be described.

FIG. 37 is a diagram illustrating a second process of providing an AR/VR service in a robot environment by an XR device according to an embodiment of the present disclosure.

While the XR device is executing the AR mode, a widget in a similar form to a robot having a communication connection established with the XR device is also displayed. Therefore, the remote robot may be controlled remotely, and a screen captured by the robot may also be provided on the AR/VR screen.

Referring to FIG. 37 again, a corresponding command is transmitted to a home robot by controlling the position or camera angle of a widget 3710 representing the home robot, displayed on an AR-mode screen. An image 3720 captured by the home robot during movement is displayed on a VR-mode screen.

Likewise, a corresponding command is transmitted to a robot cleaner by controlling the position or camera angle of a widget 3730 representing the robot cleaner, displayed on the AR-mode screen. An image 3740 captured by the robot cleaner during movement is displayed on the VR-mode screen.

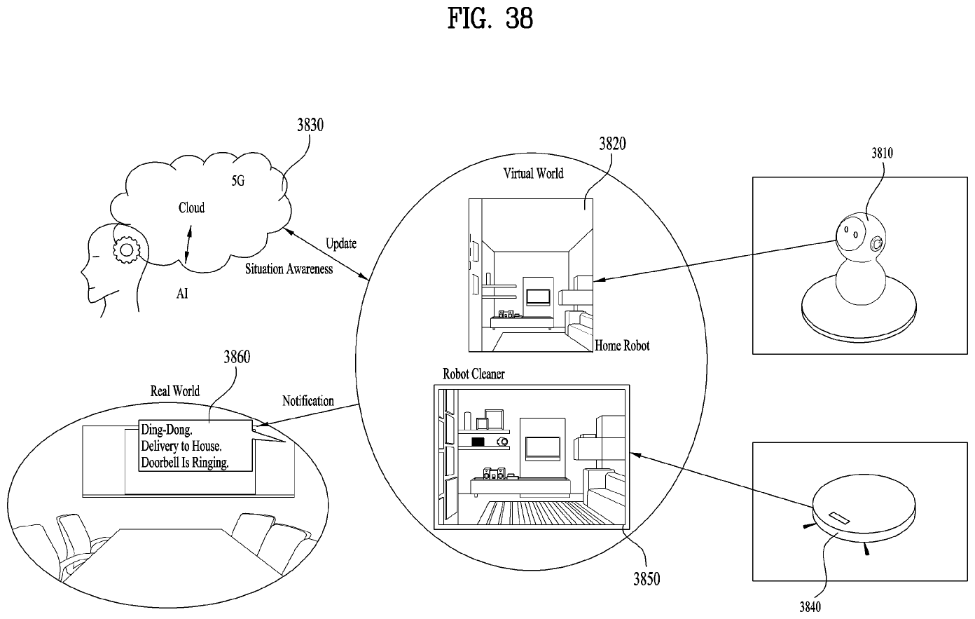

While the AR/VR service has mainly been described with reference to FIGS. 22 to 33, another embodiment in which AI, 5G, and robot environments are applied to the AR/VR service will be described with reference to FIG. 38.

FIG. 38 is a diagram illustrating a process of providing an AR/VR service in self-driving, AI, robot, and 5G environments by an XR device according to an embodiment of the present disclosure.

A first virtual object 3820 and a second virtual object 3850 are displayed on a VR-mode screen. The first virtual object 3820 is changed according to information received from a home robot 3810 connected through 5G communication, and the second virtual object 3850 is changed according to information received from a robot cleaner 3840 connected through 5G communication.

Further, the received information is transmitted to a server 3830 connected by 5G, and the server 3830 analyzes an event which has occurred in a house by AI. If the AI determines occurrence of a specific event, a notification message 3860 is automatically displayed on the AR-mode screen. Therefore, the user does not need to maintain the VR mode.

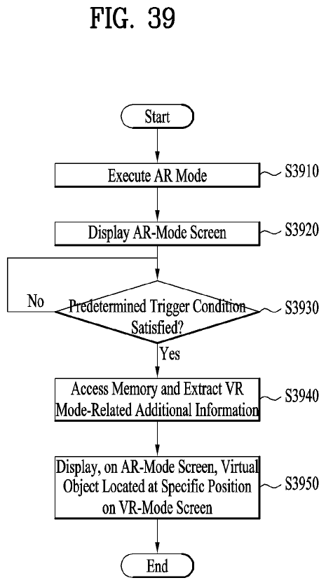

FIG. 39 is a flowchart illustrating an operation of providing an AR/VR service by an XR device according to an embodiment of the present disclosure. However, those skilled in the art will understand that implementation of another embodiment by referring to the previous drawings and FIG. 40 also falls within the scope of the present disclosure.

An XR device that provides AR mode and VR mode according to an embodiment of the present disclosure executes the AR mode (S3910).

Further, the XR device displays an AR-mode screen (S3920) and determines whether a predetermined trigger condition has been satisfied during execution of the AR mode (S3930). If determining that the predetermined trigger condition has been satisfied, the XR device accesses a memory and extracts VR mode-related additional information from the memory (S3940).

The XR device displays a virtual object, which is located at a specific position on the VR-mode screen, on the AR-mode screen based on the extracted VR mode-related additional information (S3950).

The AR-mode screen includes an object captured by, for example, the camera of the XR device, and the VR-mode screen includes at least one virtual object mapped on a position basis.

The at least one virtual object mapped to each position on the VR-mode screen is characterized in that it is changed, for example, for each user recognized by the XR device.

While not shown in FIG. 39, the method further includes tracking a user's gaze or a specific device by the XR device according to another embodiment.

The trigger condition includes, for example, recognition of the tracked user's gaze or specific device in a specific area of the AR-mode screen for a predetermined time.

The trigger condition includes at least one of, for example, a first condition that a specific physical key button on the XR device or a corresponding remote control is pushed, a second condition that a specific motion of the XR device or the corresponding remote control is sensed, or a third condition that a specific gesture is sensed by the camera of the XR device. If the trigger condition corresponds to the third condition, the method further includes changing a virtual object at a specific position on the VR-mode screen, displayed on the AR-mode screen according to the size or position of an area formed by the specific gesture.

Step S3950 further includes displaying an indicator for guiding to at least one virtual object on the VR-mode screen during execution of the AR mode.

The indicator includes at least one of, for example, first graphic data indicating the type of the at least one virtual object on the VR-mode screen, second graphic data indicating the position of the at least one virtual object on the VR-mode screen, or third graphic data indicating the number of the at least one virtual object on the VR-mode screen.

Similarly to the foregoing method, from the perspective of a device, an XR device that provides XR-related plural modes includes a memory, a controller for executing a first mode among the at least one mode, and a display for displaying a screen of the first mode. The memory, the controller, and the display may be implemented in the foregoing block diagrams. Particularly, the memory will be described below with reference to FIG. 40.

If a predetermined trigger condition is satisfied during execution of the first mode, the controller accesses the memory, extracts additional information related to a second mode from the memory, and controls the display to display a virtual object which is located at a specific position on a second-mode screen, on a first-mode screen based on the extracted second mode-related additional information. The first mode corresponds to, for example, the afore-described AR mode, and the second mode corresponds to, for example, the afore-described VR mode.

FIG. 40 is a diagram illustrating a data structure in a memory which stores parameters required for an XR device to provide an AR/VR service according to an embodiment of the present disclosure.

One feature of the present disclosure is to predefine specific parameters in a memory of an AR/VR XR device to implement the foregoing embodiments of the present disclosure, as illustrated in FIG. 40.

Conventionally, to retrieve personalized VR-mode information during execution of the AR mode, the AR mode should be wholly switched to the VR mode. In contrast, it is possible to retrieve only a part of VR-mode virtual objects during execution of the AR mode in the present disclosure.

As illustrated in FIG. 40, the same screen is provided in the AR mode irrespective of an ID. However, when a trigger condition is satisfied during execution of the AR mode, a different virtual object and a different position are defined on an ID basis in order to retrieve only a specific virtual object of the VR-mode screen.

An ID identifying a user may be input by the user or the user may be automatically identified by a camera or the like. More specifically, when a trigger condition is satisfied during execution of the AR mode in an XR device of Mr. Kim, the database illustrated in FIG. 40 is accessed, the position of additional information (virtual object) A and the position of additional information (virtual object) B on a VR-mode screen are checked, and a GUI indicating the additional information is displayed in a similar manner to FIGS. 28 to 33.

When the trigger condition is satisfied during execution of the AR mode in an XR device of Ms. Lee, the database illustrated in FIG. 40 is accessed, the position of additional information (virtual object) A and the position of additional information (virtual object) C on the VR-mode screen are checked, and a GUI indicating the additional information is displayed in a similar manner to FIGS. 28 to 33.

When the trigger condition is satisfied during execution of the AR mode in an XR device of Ms. Park, the database illustrated in FIG. 40 is accessed, the positions of additional information (virtual object) D, additional information (virtual object) E, and additional information (virtual object) F on the VR-mode screen are checked, and a GUI indicating the additional information is displayed in a similar manner to FIGS. 28 to 33. That is, because VR-mode screens are personalized, a different setting is possible for each user.

According to one of various embodiments of the present disclosure, a domain customized for each user may be provided in an AR-mode 3D space.

According to another embodiment of the present disclosure, an XR service may be provided, in which an AR-mode real object and a personalized object rendered by VR are provided together under a specific trigger condition.

According to another embodiment of the present disclosure, an inventory system may be provided, in which an AR-mode real object and a VR-mode object are provided in different modes.

According to another embodiment of the present disclosure, a sense of difference between the AR mode and the VR mode is reduced by reconstructing an AR-mode background screen with respect to a real object captured in the AR mode.

For example, if a workplace is captured in the AR mode, a real object is reconstructed as a VR-mode background screen.

Finally, according to another embodiment of the present disclosure, a service enabling fast switching between the AR mode and the VR mode may be provided.

For example, when a specific position, shape, or gesture is recognized (possibly by a device, not by a user) through ray tracking, the VR mode may be executed in the AR mode (a virtual world may be viewed in the state of the real world). On the contrary, the AR mode with augmented information (AR content) may be executed in the VR mode (the real world may be viewed in a virtual world).

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A control method of an extended reality (XR) device for providing augmented reality (AR) mode and virtual reality (VR) mode, the control method comprising:
executing the AR mode;
displaying a screen of the AR mode;
when a predetermined trigger condition is satisfied during execution of the AR mode, accessing a memory and extracting additional information related to the VR mode from the memory; and
displaying, on the screen of the AR mode, a virtual object located at a specific position on a screen of the VR mode, based on the extracted additional information related to the VR mode.

2. The control method according to claim 1, wherein the screen of the AR mode includes an object captured by a camera of the XR device, and
wherein the screen of the VR mode includes at least one virtual object mapped to each position.

3. The control method according to claim 1, wherein at least one virtual object mapped to each position on the screen of the VR mode is changed for each user recognized by the XR device.

4. The control method according to claim 1, further comprising tracking a user's gaze or a specific device by the XR device.

5. The control method according to claim 4, wherein the trigger condition includes recognition of the user's gaze or the specific device in a specific area of the screen of the AR mode for a predetermined time.

6. The control method according to claim 1, wherein the trigger condition includes at least one of a first condition that a specific physical key button of the XR device or a corresponding remote control is pushed, a second condition that a specific motion of the XR device or the corresponding remote control is sensed, or a third condition that a specific gesture is sensed by a camera of the XR device.

7. The control method according to claim 6, further comprising, when the trigger condition corresponds to the third condition, changing the virtual object located at the specific position on the screen of the VR mode, displayed on the screen of the AR mode according to a size or position of an area formed by the specific gesture.

8. The control method according to claim 1, wherein the display of, on the screen of the AR mode, a virtual object located at a specific position on a screen of the VR mode, based on the extracted additional information related to the VR mode comprises displaying an indicator for guiding to at least one virtual object on the screen of the VR mode during execution of the AR mode.

9. The control method according to claim 8, wherein the indicator includes at least one of first graphic data indicating a type of the at least one virtual object on the screen of the VR mode, second graphic data indicating a position of the at least one virtual object on the screen of the VR mode, or third graphic data indicating the number of the at least one virtual object on the screen of the VR mode.

10. A computer-readable recording medium storing a program to execute the control method according to claim 1.

11. An extended reality (XR) device for providing a plurality of modes related to XR, the XR device comprising:
a memory;
a controller configured to execute a first mode among the plurality of modes; and
a display displaying a screen of the first mode,
wherein the controller is configured to, when a predetermined trigger condition is satisfied during execution of the first mode, access the memory and extracting additional information related to a second mode from the memory, and control the display to display, on the screen of the first mode, a virtual object located at a specific position on a screen of the second mode, based on the extracted additional information related to the second mode.

12. The XR device according to claim 11, wherein the first mode corresponds to augmented reality (AR) mode, and the second mode corresponds to virtual reality (VR) mode.

13. The XR device according to claim 12, wherein the screen of the AR mode includes an object captured by a camera of the XR device, and wherein the screen of the VR mode includes at least one virtual object mapped to each position.

14. The XR device according to claim 12, wherein at least one virtual object mapped to each position on the screen of the VR mode is changed for each user recognized by the XR device.

15. The XR device according to claim 12, wherein the controller is configured to track a gaze of a user of the XR device or a specific device.

16. The XR device according to claim 15, wherein the trigger condition includes recognition of the user's gaze or the specific device in a specific area of the screen of the AR mode for a predetermined time.

17. The XR device according to claim 12, wherein the trigger condition includes at least one of a first condition that a specific physical key button of the XR device or a corresponding remote control is pushed, a second condition that a specific motion of the XR device or the corresponding remote control is sensed, or a third condition that a specific gesture is sensed by a camera of the XR device.

18. The XR device according to claim 17, wherein when the trigger condition corresponds to the third condition, the controller is configured to change the virtual object located at the specific position on the screen of the VR mode, displayed on the screen of the AR mode according to a size or position of an area formed by the specific gesture.

19. The XR device according to claim 12, wherein the controller is configured to control the display to display an indicator for guiding to at least one virtual object on the screen of the VR mode during execution of the AR mode.

20. The XR device according to claim 19, wherein the indicator includes at least one of first graphic data indicating a type of the at least one virtual object on the screen of the VR mode, second graphic data indicating a position of the at least one virtual object on the screen of the VR mode, or third graphic data indicating the number of the at least one virtual object on the screen of the VR mode.
